(19) United States
(12) Patent Application Publication
(10) Pub. No.: US 2025/0043428 A1
(43) Pub. Date: Feb. 6, 2025

(54) NANOCERAMIC COATINGS FOR METAL SUBSTRATES AND METHOD OF FORMING SAME

(71) Applicant: Wolverine Advanced Materials, LLC, Dearborn, MI (US)

(72) Inventors: Abed Hasheminasab, Dearborn, MI (US); Bryan Grace, Dearborn, MI (US); Kelly Duggan, Dearborn, MI (US); Devon Urbina, Dearborn, MI (US); Nathan Tappen, Dearborn, MI (US); Joseph Warren, Dearborn, MI (US); Aline Beaudelet, Dearborn, MI (US); Marwa Moubadder, Dearborn, MI (US)

(21) Appl. No.: 18/365,917

(22) Filed: Aug. 4, 2023

(51) Int. Cl. C23C 18/12; B01J 13/00; C23C 30/00

(52) U.S. Cl. CPC C23C 18/1254; B01J 13/0047; C23C 30/005

(57) ABSTRACT

The disclosed technology generally relates to methods for forming coatings on metal substrates to promote adhesion between the metal substrate and an elastomer layer. In one aspect, a method of forming the coated article includes providing a meal substrate, preparing a sol mixture for forming a ceramic coating, depositing the sol mixture onto a surface of the metal substrate, and then heating the metal substrate and sol mixture to form the ceramic coating. Preparing the sol mixture comprises preparing a first transition metal sol, a second transition metal sol, a metalloid sol, and then mixing the first transition metal sol, the second transition metal sol, and the metalloid sol together.

### BACKGROUND

### Field

The disclosed technology relates generally to forming coatings on metal substrates and more particularly to forming ceramic coatings on metal substrates, e.g., to promote adhesion between the metal substrate and an elastomer layer.

### Description of the Related Art

Rubber-coated articles are used in a wide variety of automotive applications, such as gaskets in fluid-sealing applications and as noise, vibration and heat insulators in a variety of applications, such as brake shims for brake rotor and pad systems. In some applications, the rubber-coated articles include a conversion coating on the metal substrate to reduce corrosion and promote adhesion between the substrate and rubber layer. However, conventional conversion coatings can be toxic to humans and harmful to the environment. Accordingly, there remains a need for protective coatings that reduce corrosion of the substrate and promote adhesion between the substrate and the rubber layer that have reduced toxicity.

### SUMMARY

In an aspect, a method of forming a coated article. The method comprises providing a metal substrate, preparing a sol mixture for forming a ceramic coating, depositing the sol mixture onto a surface of the metal substrate, and heating the metal substrate and the sol mixture to form the ceramic coating. Preparing the sol mixture comprises preparing a first transition metal sol that includes a first transition metal, preparing a second transition metal sol that includes a second transition metal that is different from the first transition metal, preparing a metalloid sol that includes a metalloid, and mixing the first transition metal sol, the second transition metal sol, and the metalloid sol together.

In another aspect, a method of coating a metal substrate. The method comprises forming a sol mixture and depositing the sol mixture onto the metal substrate. Forming the sol mixture comprises forming a first transition metal sol from a first transition metal alkoxide, forming a second transition metal sol from a second transition metal alkoxide that is different from the first transition metal alkoxide, forming a metalloid sol from a metalloid alkoxide, and mixing the first transition metal sol, the second transition metal sol, and the metalloid sol together;

In another aspect, a coated article. The coated article comprises a metal substrate, a ceramic coating adhered to a surface of the metal substrate, and an elastomer layer formed over the ceramic coating. The ceramic coating comprises a ceramic material that comprises a first transition metal, a second transition metal that is different from the first transition metal, and a metalloid.

### BRIEF DESCRIPTION OF THE DRAWINGS

FIG. 1 schematically illustrates a brake disc assembly having brake shims, according to embodiments of the present technology.

FIG. 2 schematically illustrates an engine having a gasket, according to embodiments of the present technology.

FIG. 3 illustrates a side sectional view of a coated article, according to embodiments of the present technology.

FIG. 4 illustrates a side sectional view of a coated article, according to embodiments of the present technology.

FIG. 5 is a flowchart illustrating a method of forming a sol that can be used to form a nanoceramic coating, according to embodiments of the present technology.

FIG. 6 is a flowchart illustrating a method of forming a nanoceramic coating on a substrate, according to embodiments of the present technology.

FIG. 7 is a flowchart illustrating a method of forming a nanoceramic coating on a substrate, according to embodiments of the present technology.

FIG. 8 is a flowchart illustrating a method of forming a nanoceramic coating on a substrate, according to embodiments of the present technology.

FIG. 9 is cross-sectional view of a coated article having a nanoceramic coating on a substrate.

FIGS. 10A and 10B are graphs of Nyquist plots showing how the corrosion resistance of the nanoceramic coatings changes.

FIGS. 11A-11E are images of different samples of stainless steel showing how the nanoceramic coatings affects the color of the stainless steel.

FIGS. 12A-12C illustrate an example process of forming and then modifying a sol mixture, according to embodiments of the present technology.

### DETAILED DESCRIPTION

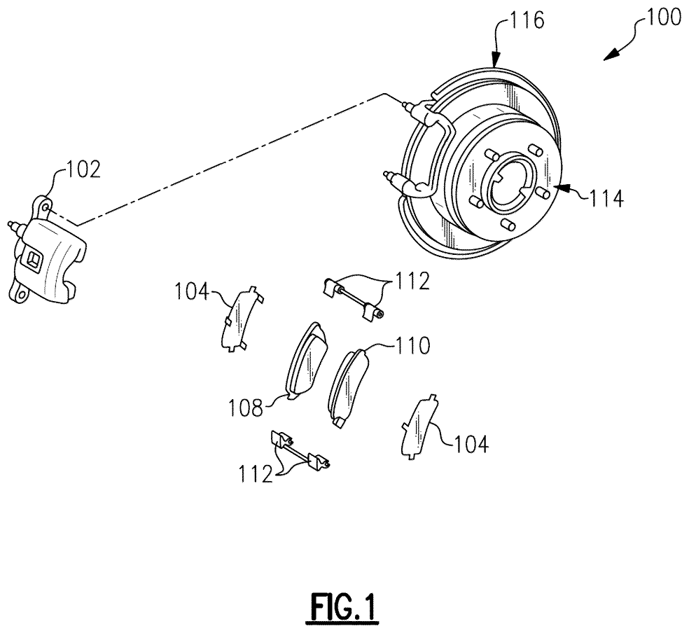

FIG. 1 illustrates an example application of a rubber-coated article having a nanoceramic pretreatment coating according to embodiments. In particular, FIG. 1 illustrates a brake disc assembly having a brake disc rotor and a corresponding pair of brake pads arranged according to aspects of the present disclosure. The example brake disc assembly 100 includes a caliper 102, a pair of brake shims 104, an inner brake pad 108, an outer brake pad 110, abutment clips 112, a hub 114, and a brake disc rotor 116. The hub 114 may be mounted on an axle (not shown). The brake disc rotor 116 has a disc shape and is a part of the hub 114. The brake disc rotor 116 is configured to rotate along with the hub 114 through the axle. When pressure is applied to a brake pedal of a vehicle, various systems in the vehicle will responsively actuate the caliper 102 to urge the surface of the inner and outer brake pads 108, 110 against a surface of the brake disc rotor 116, thus bringing the vehicle to a halt. The brake shims 104 are positioned between the brake pads 108, 110 and the caliper 102 such that, when pressure is applied to the brake pedal, the calipers push on the brake shims 104, which then push on the brake pads 108, 110. The brake shims 104 are configured to absorb impacts on the brake pads 108, 110 caused by the brake pads 108, 110 contacting the brake disc rotor 116 during the braking process such that the brake pads 108, 110 do not contact the caliper 102. As described in greater detail elsewhere in the application, the shims 104 are formed from a thin piece of metal that may be coated with an elastomer layer according to various embodiments disclosed herein. In this way, the brake shims 104 can reduce noise and vibration noise that may occur during brake application when the brake pads 108, 110 contact the brake disc rotor 116.

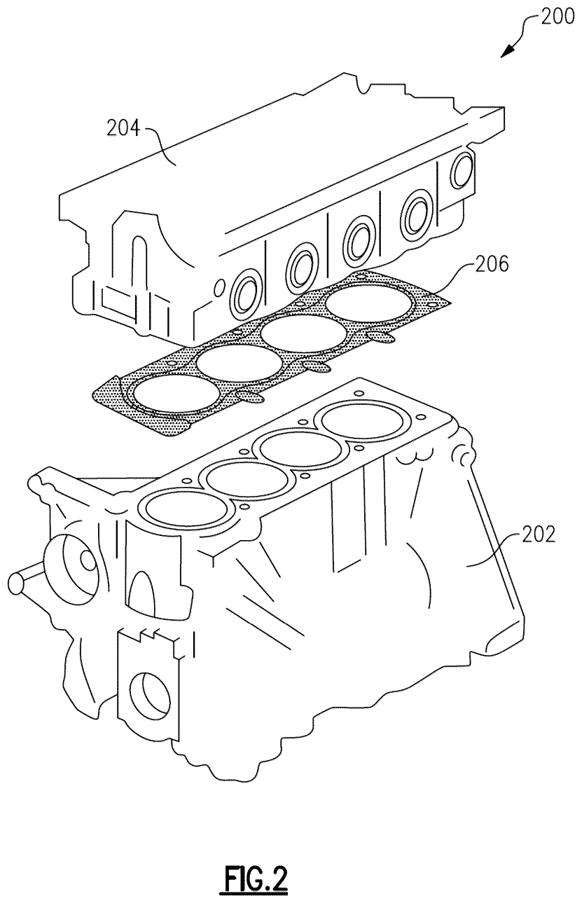

FIG. 2 illustrates another example application of a rubber coating formed using aqueous formulation according to embodiments. In particular, FIG. 2 illustrates internal combustion engine 200 used in automotive applications. The engine 200 includes an engine block 202, a cylinder head 204, and a gasket 206. The engine block 202 and cylinder head 204 each include various fluid passages and the engine block 202 and cylinder head 204 are aligned such that the fluid passages within the cylinder head 204 are in fluid connection with corresponding fluid passages in the engine block 202. For example, the engine block 202 and cylinder head 204 each include coolant and oil passages and the engine block 202 and cylinder head 204 are aligned such that coolant passages within the engine block 202 are in fluid connection with coolant passages within the cylinder head 204 while oil passages within the engine block 202 are in fluid connection within the cylinder head 204. The engine block 202, cylinder head 204, and gasket 206 are secured together (e.g., with bolts that extend through the engine block 202, cylinder head 204, and gasket 206) such that the gasket 206 is securely positioned between the engine block 202 and the cylinder head 204. The gasket 206 includes a plurality of openings that correspond to the various fluid passages within the engine block 202 and cylinder head 204 to allow for the fluids to move between the engine block 202 and cylinder head 204. The gasket 206 is configured to form a seal between the engine block 202 and cylinder head 204 so that the fluids flowing through the various passages between the engine block 202 and the cylinder head 204 remain in their respective passages and do not leak into adjacent passages or out of the engine 200. The gasket 206 also prevents fluids from leaking into the cylinders where combustion takes place, prevents fuel/air from the cylinders from leaking into the fluid passages, and prevents fuel/air from one cylinder from leaking into an adjacent cylinder. Fluid leaks in an engine can reduce the performance of the engine and can even cause damage to the engine.

As described in greater detail elsewhere in the application, the gasket 206 is formed from a thin piece of metal coated with an elastomer layer according to various embodiments disclosed herein. In some embodiments, the elastomer layer is a foamed or non-foamed elastomer that is configured to be compressed between the engine block 202 and the cylinder head 204. In the illustrated embodiment, the gasket 206 is a head gasket configured to be positioned between the engine block 202 and the cylinder head 204. In other embodiments, however, the gasket 206 can be another type of gasket used in the engine 200. For example, in some embodiments, the gasket 206 can be a valve cover gasket, an exhaust manifold gasket, or an intake manifold gasket. In still other embodiments, the gasket 206 can configured to be used in other automotive systems, such as exhaust systems, transmission systems, or fuel pump systems. In still other embodiment, the gasket 206 is configured to be in a non-automotive application, such as in power generation systems, aeronautical systems, or nautical systems. In general, the gasket 206 can be used in any application where a tight seal is needed to prevent leaks.

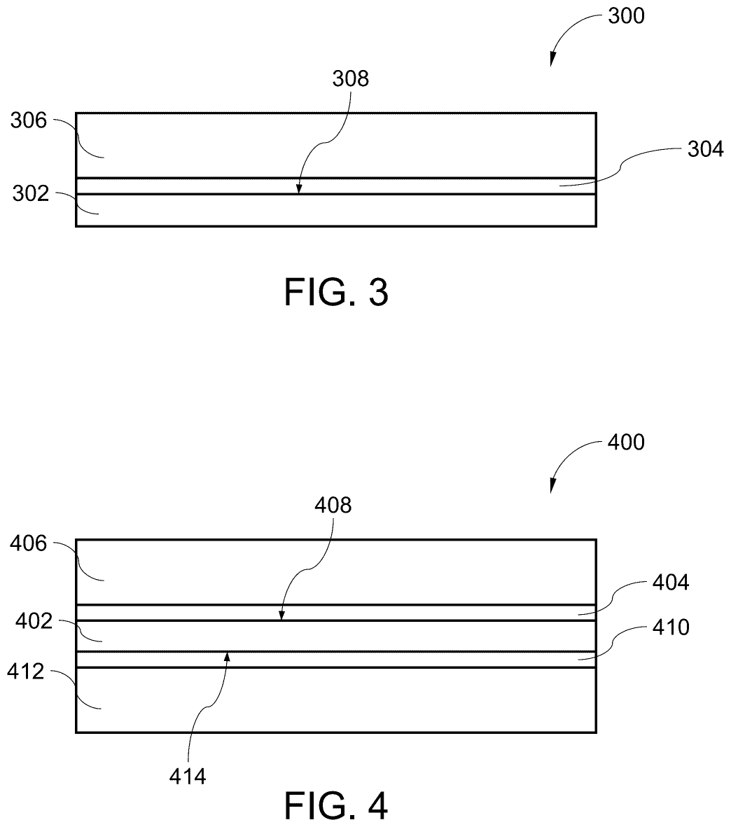

FIG. 3 is a side sectional view of a coated article 300 according to embodiments. The coated article 300 includes a substrate 302 having formed thereon a coating 304 and an elastomer layer 306. In some embodiments, the coating 304 may be a nanoceramic pretreatment coating which can promote, among other effects, adhesion of the elastomer layer 306. As discussed in greater detail elsewhere in the specification, the nanoceramic pretreatment coating is formed from various precursor compounds, which typically comprise nanoparticles. Accordingly, the “nano-” prefix in “nanoceramic” refers to the size of the precursor compounds used to form the coating. While the coating 304 can enhance the adhesion of the elastomer layer 306 when present, it will be appreciated that the elastomer layer 306 may be omitted in some implementations. For example, the coating 304 may provide corrosion resistance to the underlying substrate 302 with or without the elastomer layer 306. The substrate 302 is configured to provide structure for the coated article 300 and to support the elastomer layer 306. In some embodiments, the substrate 302 may be formed from a metal. For example, in some embodiments, the substrate 302 can comprise a stainless steel, a cold rolled steel, a galvanized steel, or an aluminum-based metal. In other embodiments, however, the substrate 302 is formed from a different material. For example, in some embodiments, the substrate 302 is formed from a non-metallic material such as a plastic, ceramic, glass, or textile material.

The elastomer layer 306 is formed over the coating 304 and is formed from a vulcanized elastomer latex solution that is configured to be elastically deformable such that it is compressible. The elastomer layer 306 may be fluorinated or non-fluorinated. In some embodiments, the elastomer layer 306 comprises natural rubber (NR), carboxylated acrylonitrile butadiene rubber (XNBR), fluorinated rubber (FKM), or ethylene propylene diene monomer rubber (EPDM). In other embodiments, however, the elastomer layer 306 is comprises a different type of rubber. The elastomer layer 306 is formed by depositing an uncured (or only partially cured) rubber solution over the nanoceramic pretreatment coating 304 and then drying and fully curing the rubber solution. During the drying and curing process, which is typically referred to as vulcanization, cross-linking between the long-chain polymer molecules in the rubber solution occurs, which causes the fluid solution to harden and stiffen and the strength of the rubber to increase. The resulting solid material is relatively tough and durable while still being sufficiently flexible over a wide temperature range. The vulcanized latex material is also able to withstand environments typically seen in sealing and brake applications. For example, the vulcanized latex material is capable of maintaining its flexibility and toughness even when exposed to high pressures and/or elevated temperatures. Additionally, the material is chemically stable and unreactive and maintains its flexibility and toughness even after being exposed to fluids commonly found in automobile applications, such as motor oils, greases, transmission fluids, brake fluids, coolants, etc. In this way, the elastomer layer 306 provides, among other advantages, sufficient vibration and noise damping when the coated article 300 is used, e.g., in braking applications, and is sufficiently compressible to form a seal when the coated article 300 is used, e.g., in sealing applications.

The coating 304 is formed on a surface 308 of the substrate 302 such that the nanoceramic pretreatment coating 304 is disposed between, e.g., contacting, the substrate 302 and the elastomer layer 306. Among other effects, the coating 304 is configured to modify the surface 308 of the substrate 302 so as to enhance adhesion of the elastomer layer 306 to the substrate 302. For example, the nanoceramic pretreatment coating 304 is configured to increase the strength of the bond between the elastomer layer 306 and the substrate 302 so that the elastomer layer 306 remains adhered to the substrate 302 during braking and scaling operations. In some embodiments, the nanoceramic pretreatment coating 304 is also configured to form a protective layer for the substrate 302 to improve the corrosion resistance of the substrate 302 when the coated article 300 is exposed to harsh hydrothermal conditions found in automotive application. For example, the nanoceramic pretreatment coating 304 is configured to protect the substrate 302 from corrosion when the coated article 300 is exposed to fluids commonly found in automotive braking and sealing applications, such as motor oils, greases, coolants, transmission fluids, and brake fluids, as well as to harsh thermal and environmental conditions, such as high temperatures and pressures and road salt.

In some embodiments, the coating 304 comprises a ceramic coating. As described in greater detail elsewhere in the specification, the ceramic coating 304 is formed by mixing various transition metal compounds, metalloid compounds, solvents, and other additives together according to various suitable manufacturing techniques, depositing the mixture onto the substrate 302, and then heating the mixture to cause it to undergo a condensation reaction. As the condensation reaction proceeds, the transition metal compounds, metalloid compounds, and additives bond together to form a sol-gel, which can be applied to a surface of the substrate 302 to form ceramic particles that are bonded the surface of the substrate 302. In some embodiments, the ceramic particles can have a diameter between 1 μm and 20 μm and can include atoms from one or more transition metal elements and atoms from one or more metalloid elements. In some embodiments, the nanoceramic coating 304 is formed from a sol-gel that is formed from the transition metal and metalloid compounds. In some embodiments, the ceramic particles also include a chelating agent. In some embodiments, the ceramic coating 304 can be amorphous or semi-amorphous. For example, the ceramic coating 304 can include ceramic particles and an amorphous or glassy ceramic phase.

Elastomer-coated articles used in automotive applications typically include a conversion coating formed between the elastomer layer and the metal substrate. These conversion coatings, which typically include chromate conversion coatings and phosphate conversion coatings, are configured to promote adhesion between the metal substrates and the elastomer material. However, chromate and phosphate conversion coatings can be harmful to humans and the environment. For example, chromium conversion coatings are typically formed from hexavalent chromium compounds that are toxic to humans and are highly regulated. Additionally, phosphate conversion coatings are harmful to the environment as the coating process results in phosphates and other chemicals being introduced into surface water systems. Advantageously, the nanoceramic pretreatment coating 304 provides similar adhesion and corrosion resistance properties as chromium and phosphate conversion coatings but does not have the same environmental and health drawbacks as the chromium and phosphate conversion coatings do.

In the illustrated embodiment, the coated article 300 includes a substrate 302, a nanoceramic coating 304, and an elastomer layer 306 that forms a topcoat for the coated article 300, where the elastomer layer 306 comprises fluorinated or non-fluorinated rubber and the nanoceramic coating 304 is configured to provide corrosion resistance to the substrate and also to improve adhesion between the elastomer layer 306 and the substrate 302. In other embodiments, however, the coated article 300 does not include an elastomer layer 306. Instead, the coated article 300 can have a topcoat formed from a different material or no topcoat. For example, in some embodiments, the coated article 300 includes a topcoat formed from other materials used in automotive sealing and braking applications, such as a thermoset material, an epoxy, a polyester, or a urethane. In these embodiments, the nanoceramic coating 304 is configured to also improve adhesion between the substrate 302 and the topcoat.

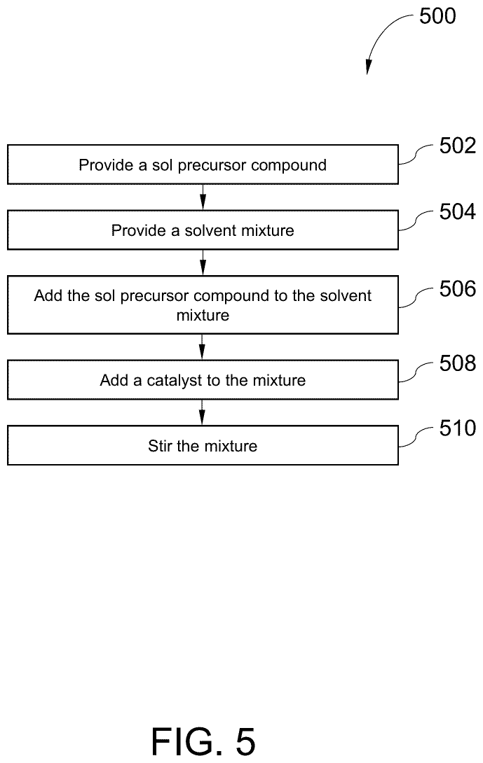

Referring to FIG. 3, in the illustrated embodiment, the coated article 300 includes the nanoceramic coating 304 and the nanoceramic elastomer layer 306 formed on a single side of the substrate 302. In other embodiments, however, the coated article can include a nanoceramic coating and elastomer layers on both sides of the substrate. FIG. 4 is a side sectional view of a coated article 400 having a substrate 402, a first nanoceramic pretreatment coating 404 formed on a first surface 408 of the substrate, a first elastomer layer 406 formed over the first nanoceramic pretreatment coating 404, a second nanoceramic pretreatment coating 410 formed on a second surface 414 of the substrate 402, and a second elastomer layer 412 formed on the second nanoceramic pretreatment coating 410. In some embodiments, the first and second nanoceramic pretreatment coatings 404, 410 can have the same thickness, composition, and structure. In other embodiments, however, the first and second nanoceramic pretreatment coatings 404, 410 can have different thicknesses, compositions, and/or structures. For example, in some embodiments, the first nanoceramic pretreatment coating 404 can have a composition that includes a first transition metal (e.g., zirconium) while the second nanoceramic pretreatment coating 410 can have a composition that includes a second transition metal that is different from the first transition metal (e.g., cobalt). Similarly, in some embodiments, the first and second elastomer layers 406, 412 also have the same thickness, composition, and structure. In other embodiments, however, the first and second elastomer layers 406, 412 can have different thicknesses, compositions, and/or structures. For example, in some embodiments, while both layers 406, 412 can be un-foamed elastomers, the first elastomer layer 406 can be thicker than the second elastomer layer 412. In other embodiments, the first elastomer layer 406 can be formed from a foamed elastomer material while the second elastomer layer 412 is formed from an un-foamed elastomer material. In general, the thickness, composition, and structure of the first and second nanoceramic pretreatment coatings 404, 410 and the first and second elastomer layers 406, 412 can be selected based on the specific application in which the coated article 400 is intended to be used. In some embodiments, the coated article 400 includes first and second nanoceramic pretreatment coatings 404, 410 formed on the first and second surfaces 408, 414 but the coated article 400 does not include one of the elastomer layers 406, 412. For example, in some embodiments, the coated article 400 only includes the first elastomer layer 406 and does not include the second elastomer layer 412.

The nanoceramic pretreatment coatings, 304, 404, 410 comprise a layer of ceramic particles formed on the substrate and can be formed according to various suitable manufacturing techniques. For example, in some embodiments, the coatings are formed by depositing a sol onto a substrate and then heating the sol to cause it to undergo a polycondensation reaction to form a solidified sol-gel. In some embodiments, multiple sols are mixed together before being deposited onto the substrate. As discussed in greater detail elsewhere in the application, a sol is a colloidal suspension of solid polymeric particles in a continuous liquid medium. In some embodiments, a sol can be modified by grafting various chelating agents and functional groups to the sol's polymer backbone. However, manufacturing techniques that can be used to form the nanoceramic pretreatment coatings are not limited to embodiments that include forming a sol-gel from one or more sols. For example, in other embodiments, the nanoceramic pretreatment coating can be formed by mixing various sol precursor compounds together, depositing the mixture onto the substrate, and then heating the mixture. In still other embodiments, the nanoceramic pretreatment coatings can be formed by blending together various sol precursor compounds, acids, corrosion inhibitors, and chelating agents, depositing the blended mixture onto the substrate, and then heating the blended mixture.

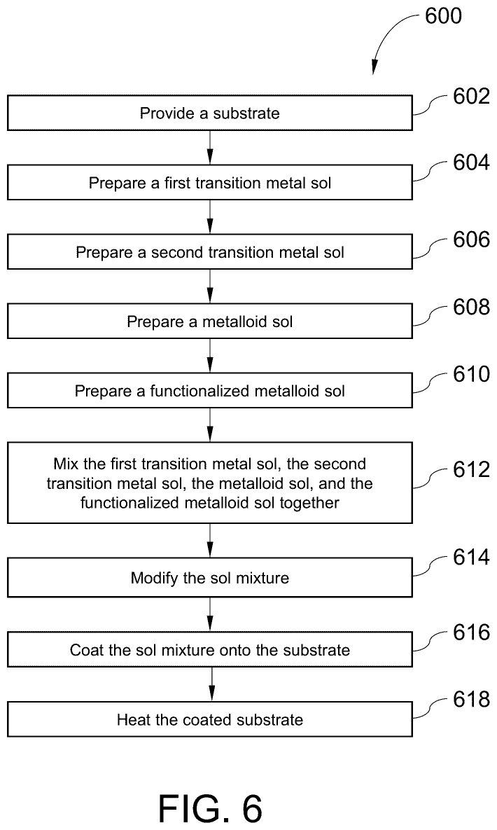

FIG. 5 is a flowchart illustrating a process 500 for forming a sol that can be used to form a coating, e.g., a nanoceramic pretreatment coating. At block 502, a sol precursor compound is provided. The sol precursor compound comprises a central atom and a plurality of ligands (e.g., four ligands) bonded to the central atom. In some embodiments, the central atom comprises an atom of a transition metal element. In other embodiments, the central atom comprises an atom of a metalloid element. In some embodiments, the sol precursor compound comprises a transition metal alkoxide or a metalloid alkoxide. In these embodiments, the ligands are alkoxides that each include an organic group bonded to a negatively charged oxygen atom, which is single-bonded to the central atom. In these embodiments, the sol precursor compound can have a chemical formula of X(OR)₄, where X is the central atom and R is the organic group. In some embodiments, the organic group R comprises an alkyl group, which comprise carbon and hydrogen atoms and have a general formula of CₙH₂ₙ₊₁. The smallest alkyl groups are methyl, which has the chemical formula of CH₃, and ethyl, which has the chemical formula of C₂H₅. In other embodiments, however, the organic group does not comprise an alkyl group and instead includes a different organic group. In some embodiments, the alkoxide ligands bonded to the central atom are all the same. For example, in some embodiments, each of the alkoxide ligands comprises a butoxide ligand (—OCH₂CH₂CH₂CH₃). In other embodiments, however, at least one of the alkoxide ligands is different from the other ligands bonded to the central atom. However, the sol is not limited to embodiments where the sol precursor compound comprises a metal or metalloid alkoxide. Accordingly, in some embodiments, one or more of the ligands bonded to the central atom comprises a non-alkoxide ligand. For example, in some embodiments, one or more of the ligands bonded to the central atom is a single chlorine atom. In some embodiments, the sol precursor compounds are provided in powder form. In other embodiments, however, the sol precursor compounds can be provided in acid form.

At block 504, a solvent mixture is provided. In some embodiments, the solvent mixture includes a primary alcohol and distilled water. In other embodiments, the solvent mixture can include one or more other solvents in addition to the primary alcohol and distilled water. In some embodiments, the primary alcohol comprises one or more of methanol, ethanol, propanol, or some other alcohol.

At block 506, the sol precursor compound is added to the solvent mixture. Adding the sol precursor compound to the solvent mixture causes the sol precursor compound to react with the water in the mixture and undergo a hydrolysis reaction whereby the ligands attached to the central atom are replaced by hydroxyl groups (OH). During the hydrolysis reaction, water molecules cause the bond between the central atom and one or more of the ligands to break. One of the hydrogen ions (H+) from the water molecule bonds with the negatively-charged ligand while the remaining hydroxyl ion (OH—) from the water molecule bonds to the central atom, replacing the ligand. The resulting hydrolyzed sol precursor compound comprises the central atom and a plurality of hydroxyl group ligands (e.g., four hydroxyl group ligands) bonded to the central atom. In embodiments where each of the ligands comprises an alkoxide group ligand, this process can occur according to the following reaction, without being bound to any theory, where X is the central atom:

X(OR)₄+H₂O→X(OH)₄+HOR

However, these hydrolysis reactions can often be slow such that not all of the ligands undergo the hydrolysis reaction (or may not undergo the hydrolysis reaction in a reasonable amount of time, e.g., a few hours to a day). Accordingly, at block 508, a catalyst can be added to the mixture. In some embodiments, the catalyst comprises an acid. In these embodiments, the acid can be added to the mixture in catalytic amounts and the acid can be configured to catalyze the hydrolysis reaction to ensure that the reaction goes to completion and occurs within a reasonable amount of time. Suitable acids that can be included in the solvent mixture include acetic acid (CH₃COOH), hydrochloric acid (HCl), nitric acid (HNO₃), phosphoric acid (H₃PO₄), sulfuric acid (HSO₄), and hydrofluoric acid (HF). In other embodiments, however, the catalyst does not include an acid. For example, in some embodiments, the catalyst comprises a base. In these embodiments, the base can be added to the mixture in catalytic amounts and the base can be configured to catalyze the hydrolysis reaction to ensure that the reaction goes to completion and occurs within a reasonable amount of time. Suitable bases that can be included in the solvent mixture include ammonia (NH₃), sodium hydroxide (NaOH), potassium hydroxide (KOH), calcium hydroxide (Ca(OH)₂), and sodium bicarbonate (NaHCO₃). In some embodiments, the catalyst used can be based on the sol precursor compound being used. In other embodiments, however, the catalyst can be selected to affect the morphology of the final sol-gel formed from the sols. For example, sols catalyzed by an acid can form weakly cross-linked sol-gels while sols catalyzed by a base can form highly branched clusters. On the other hand, in some embodiments where the precursor compounds are provided in acid form, a separate catalyst may not be provided and process 500 can be performed without block 508.

In the illustrated embodiment, the catalyst is added to the mixture after the sol precursor compound is added to the solvent mixture. In other embodiments, however, the catalyst is added at another time. For example, in some embodiments, the catalyst is added to the solvent mixture before the sol precursor compound is added to the mixture. In other embodiments, however, the catalyst is added to the mixture at the same time that the sol precursor compound is added to the solvent mixture. In still other embodiments, the sol precursor can be mixed with the catalyst before the sol precursor compound is added to the solvent mixture.

At block 510, the mixture is stirred until the hydrolysis reaction has completed. In some embodiments, the mixture is stirred without the mixture being heated. In these embodiments, the hydrolysis reaction occurs at a temperature of about 10-50° C., for instance about 20° C., and the reaction takes between 12 hours and 24 hours to complete. In other embodiments, however, the mixture is heated to a higher temperature to increase the reaction rate. For example, in some embodiments, the mixture is heated to a temperature greater than 50° C. (e.g., a temperature between 100° C. and 150° C.) and the reaction takes between 2 and 3 hours to complete. In other embodiments, however, the mixture is heated to a different temperature and the reaction takes a different amount of time to complete. For example, in some embodiments, the mixture is heated to a temperature 50° C., 60° C., 70° C., 80° C. 90° C., 100° C., 110° C. 120° C., 130° C., 140° C., 150° C., or a temperature in a range defined by any of these values, and the reaction takes 0.5 hours to complete, 1 hour to complete, 1.5 hours to complete, 2 hours to complete, 2.5 hours to complete, 3 hours to complete, more than 3 hours to complete, or a time in a range defined by any of these values.

In some embodiments, after one or more of the alkoxide ligands have hydrolyzed, the hydrolyzed sol precursor compounds can undergo a polycondensation reaction to form a network of solid-phase oxide (e.g., transition metal oxide or metalloid oxide) nanoparticles suspended in a solvent solution. In a polycondensation reaction, a polymer chain (or network) is formed when multiple species/compounds bond together via condensation reactions, which are reactions that result in a water molecule (or some other small molecule) being released as a byproduct. For example, when a first molecule of the hydrolyzed sol precursor compound X¹(OH)₄ interacts with a second molecule of the hydrolyzed sol precursor compound X²(OH)₄, the two molecules can bond together (via an oxygen atom) and release a water molecule. More specifically, one of the hydroxyl group ligands bonded to the central atom X¹ can react with one of the hydroxyl group ligands bonded to the central atom X² of the second molecule, which can result in a water molecule being released and the two central atoms X¹, X² both being single-bonded to the remaining oxygen atom, without being bound to any theory, according to the following reaction:

X¹(OH)₄+X²(OH)₄→(OH)₃X¹—O—X²(OH)₃+H₂O

Afterwards (or simultaneously), the other hydroxyl groups bonded to the central atoms X¹, X² can also react with the hydroxyl group ligands from other hydrolyzed sol precursor compounds within the sol. For example, each of the central atoms can bond to multiple other central atoms (via shared oxygen atoms), thereby forming a solid-phase metal oxide (or metalloid oxide) particle. For example, a central atom having a valency of 4+ can bind to four other central atoms. This reaction occurs spontaneously throughout the sol such that many oxide particles are present in the sol. However, this reaction tends to be energetically and/or kinetically unfavorable at room temperatures (e.g., at temperatures between 10° C. and 30° C.), and the reaction rate may be slow, resulting in relatively small solid-phase particles. For example, in some embodiments, the oxide particles can be nanoparticles having a diameter between 1 μm and 20 μm. Additionally, in some embodiments, only some of the hydrolyzed sol precursor compound molecules in the sol may react with another molecule. Accordingly, in some embodiments, the sol can include both hydrolyzed precursor compound molecules and oxide particles suspended in the solvent mixture.

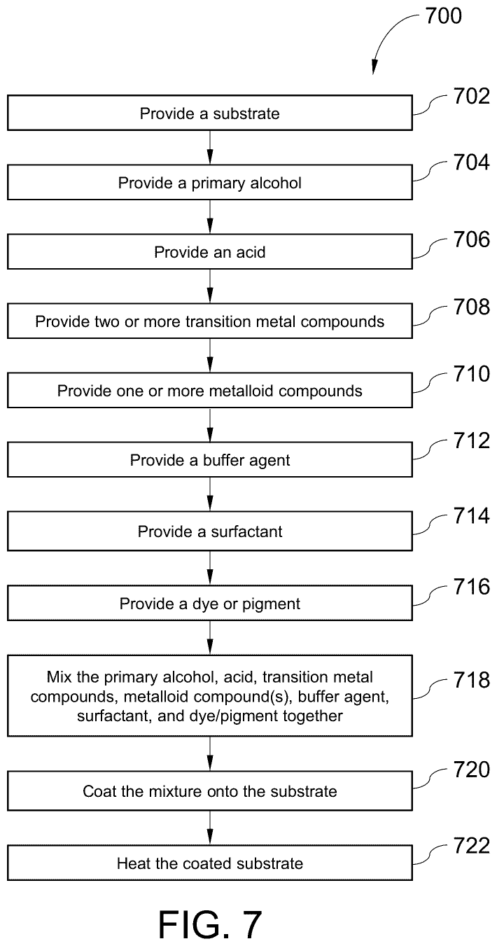

FIG. 6 is a flowchart illustrating a process 600 for forming a coating, e.g., a nanoceramic pretreatment coating, on a substrate from a sol-gel. At block 602, a substrate is provided. As described above in connection with FIGS. 3 and 4, the substrate can comprise or be formed from metal, such as stainless steel, cold rolled steel, galvanized steel, or aluminum. The substrate can be configured to provide structure and support to the nanoceramic pretreatment coating and any other layers that are subsequently formed over the nanoceramic pretreatment coating (e.g., a cured elastomer layer).

At block 604, a first transition metal sol is formed. The first transition metal sol is formed according to the process described above in connection with FIG. 5 and is formed by mixing a transition metal sol precursor compound into a solvent mixture to cause the transition metal sol precursor to undergo a hydrolysis reaction. The transition metal sol precursor compound comprises a central transition metal atom and a plurality of ligands bonded to the central transition metal atom. The number of ligands can depend on the valency of the central transition metal atom. The number of ligands can be, e.g., 2-6, e.g., 4. In some embodiments, the central transition metal atom comprises an atom of copper (Cu), cobalt (Co), manganese (Mn), zinc (Zn), titanium (Ti), zirconium (Zr), tantalum (Ta), hafnium (Hf), or vanadium (V). In some embodiments, the transition metal sol precursor compound comprises a transition metal alkoxide that includes a plurality of alkoxide ligands bonded to the central transition metal atom (e.g., four alkoxide ligands bonded to the central transition metal atom). Examples of suitable transition metal sol precursor compounds include titanium alkoxides (e.g., titanium butoxide, titanium isopropoxide), zirconium alkoxides (e.g., zirconium butoxide, zirconium, isopropoxide, zirconium propoxide), copper alkoxides, cobalt hydroxychlorides, tantalum butoxide, hafnium t-butoxide, vanadium oxytripropoxide, titanium chloride, and zirconium chloride. As described elsewhere in the application, in some embodiments, at least one of the transition metal sol precursor compounds can be provided in acid form. Examples of suitable acid forms of the transition metal sol precursor compounds include hexafluorozirconic acid and hexafluorotitanic acid.

The transition metal sol precursor compound is added to the solvent mixture to cause the alkoxide ligands in the precursor compound to hydrolyze. The resulting hydrolyzed transition metal sol precursor comprises the central transition metal atom and a plurality of hydroxyl ligands (e.g., four hydroxyl ligands) bonded to the central transition metal atom. In some embodiments, a catalyst (e.g., an acid or a base) can be added to the mixture to ensure that the reaction goes to completion and/or completes in a reasonable amount of time. The mixture is stirred until the hydrolysis reaction has completed. In some embodiments, the mixture is stirred without heating the mixture. In other embodiments, however, the mixture is heated to increase the reaction rate. In some embodiments, after one or more of the ligands have hydrolyzed, some of the hydrolyzed first transition metal sol precursor compound molecules in the first transition metal sol can undergo a polycondensation reaction to form solid-phase nanoparticles of metal oxide that include transition metal atoms bonded to oxygen atoms.

At block 606, a second transition metal sol is formed. The second transition metal sol can be formed according to the process described above in connection with FIG. 5 and is formed by mixing a transition metal sol precursor compound into a solvent mixture to cause the transition metal sol precursor to undergo a hydrolysis reaction. In some embodiments, however, the second transition metal sol can be formed from a transition metal sol precursor compound having a different central transition metal atom than the transition metal sol precursor compound that the first transition metal sol is formed from. For example, in embodiments where the first transition metal sol is formed from a transition metal sol precursor compound having a titanium central atom (e.g., titanium butoxide), the second transition metal sol can be formed from a transition metal sol precursor having a non-titanium central transition metal atom, such as a transition metal sol precursor having a zirconium central atom (e.g., zirconium isopropozide), a copper central atom, or a cobalt central atom. In some embodiments, the first and second transition metal sols can be formed from transition metal sol precursor compounds having the same number and type of ligands. For example, in embodiments where the first transition metal sol is formed from titanium butoxide, which has four ligands that each include an oxygen atom and a butyl group (—CH₂CH₂CH₂CH₃) bonded to the oxygen atom, the second transition metal sol can be formed from zirconium butoxide, which also has four ligands that each include an oxygen atom and a butyl group bonded to the oxygen atom. In other embodiments, however, the first and second transition metal sols can be formed from transition metal sol precursor compounds having a different number and/or type of ligands. For example, in embodiments where the first transition metal sol is formed from titanium butoxide, the second transition metal sol can be formed from zirconium propoxide, which has four ligands that each include an oxygen atom and a propyl group (—CH₂CH₂CH₃) bonded to the oxygen atom.

The second transition metal sol precursor compound is added to the solvent mixture to cause the alkoxide ligands in the precursor compound to undergo a hydrolysis reaction. The resulting hydrolyzed transition metal sol precursor comprises the central transition metal atom and a plurality of hydroxyl ligands (e.g., four hydroxyl ligands) bonded to the central transition metal atom. In some embodiments, a catalyst (e.g., an acid or a base) can be added to the mixture to ensure that the reaction goes to completion and/or completes in a reasonable amount of time. The mixture is stirred until the hydrolysis reaction has completed. In some embodiments, the mixture is stirred without heating the mixture. In other embodiments, however, the mixture is heated to increase the reaction rate. In some embodiments, after one or more of the ligands have hydrolyzed, some of the hydrolyzed second transition metal sol precursor compounds in the first transition metal sol can undergo a polycondensation reaction to form solid-phase nanoparticles of metal oxide that include transition metal atoms bonded to oxygen atoms.

Still referring to FIG. 6, at block 608, a metalloid sol is prepared. The metalloid sol is formed according to the process described above in connection with FIG. 5 and is formed by mixing a metalloid sol precursor compound into a solvent mixture to cause the metalloid sol to undergo a hydrolysis reaction. The metalloid sol precursor compound comprises a central metalloid atom and a plurality of ligands (e.g., four ligands) bonded to the central metalloid atom. The number of ligands bonded to the central metalloid atom can depend on the valency of the of the central metalloid atom. Metalloids are elements whose properties are intermediate between those of metals and those of solid nonmetals or semiconductors and include elements such as silicon, boron, germanium, and antimony. Accordingly, in some embodiments, the central metalloid atom comprises an atom of silicon (Si), boron (B), germanium (Ge), antimony (Sb), or some other metalloid element. In some embodiments, the metalloid sol precursor compound comprises a metalloid alkoxide that includes a plurality of alkoxide ligands bonded to the central metalloid atom (e.g., four alkoxide ligands bonded to the central metalloid atom). Examples of suitable metalloid sol precursor compounds include tetraethyl orthosilicate, tetra-n-propoxysilane, tetramethoxy silane, antimony (III) methoxide, antimony (III) ethoxide, antimony (III) butoxide, germanium (IV) methoxide, germanium (IV) isopropoxide, and germanium (IV) ethoxide. By way of specific examples and without limitation, the metalloid sol precursor compound can include, be derived from, or by compounded with any of the following structures:

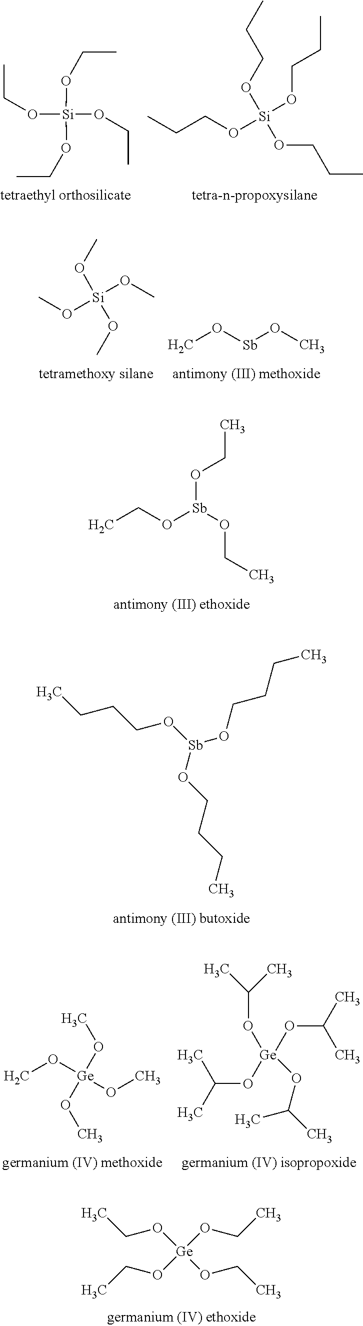

The metalloid sol precursor compound is added to the solvent mixture to cause the alkoxide ligands in the precursor compound to hydrolyze. The resulting hydrolyzed metalloid sol precursor comprises the central metalloid atom and a plurality of hydroxyl ligands (e.g., four hydroxyl ligands) bonded to the central metalloid atom. In some embodiments, a catalyst (e.g., an acid or a base) can be added to the mixture to ensure that the reaction goes to completion and/or completes in a reasonable amount of time. The mixture is stirred until the hydrolysis reaction has completed. In some embodiments, the mixture is stirred without heating the mixture. In other embodiments, however, the mixture is heated to increase the reaction rate. In some embodiments, after one or more of the ligands have hydrolyzed, some of the hydrolyzed metalloid sol precursor compound molecules in the first transition metal sol can undergo a polycondensation reaction to form solid-phase nanoparticles of metalloid oxide that include metalloid atoms bonded to oxygen atoms.

At block 610, a functionalized metalloid sol is formed. Unless otherwise noted, the functionalized metalloid sol can be formed according to the process described above in connection with FIG. 5. The functionalized metalloid sol is formed by mixing a functionalized metalloid sol precursor compound into a solvent mixture to cause the functionalized metalloid sol precursor compound to undergo a hydrolysis reaction. The functionalized metalloid sol precursor compound comprises a central metalloid atom, one or more alkoxide ligands bonded to the central metalloid atom, and one or more functional group ligands bonded to the central metalloid atom. The combined number of the ligand(s) and the functional group ligand(s) can depend on the valency of the central metalloid atom and can be a number between 2-6, e.g., four. In some embodiments, the functionalized metalloid sol precursor compound comprises 3 alkoxide ligands and 1 functional group ligand. The central metalloid atom comprises an atom of silicon (Si), boron (B), germanium (Ge), antimony (Sb), or a different metalloid element. The functional group ligand comprises a group of atoms configured to bond with organic and inorganic materials. As discussed in greater detail elsewhere in the application, in some embodiments, the sol can be modified by grafting various chelating agents to the polymeric particles within the sol to modify various aspects of the nanoceramic coating formed from the sol. In some embodiments, the chelating agent can graft onto the polymeric particles in the sol by bonding to the functional group ligand. Accordingly, in some embodiments, the functional group ligand can be selected such that the chelating agent can bond to the functional group ligand. For example, in some embodiments, the chelating agents selected to modify the sol have hydroxyl or amine groups. In these embodiments, the functional group can be selected such that it is reactive with either hydroxyl or amine groups. In some embodiments, the functionalized metalloid sol precursor compound comprises a functional silane. In some embodiments, the functional group ligand of has an epoxy functionality, an isocyanate functionality, or an amine functionality. Examples of suitable functionalized metalloid sol precursor compounds include hydroxymethyl triethoxysilane, 3-aminopropyl triethoxysilane, 3-aminopropyl trimethoxy silane, aminophenyl trimethoxysilane, 5,6-epoxyhexyl triethoxysilane, 3-glycidoxyoctyl trimethoxysilane, (3-glycidyloxypropal)trimethoxysilane, (3-glycidoxy propyl)methyldiethoxysilane, 1-(3-glycidoxypropyl)-1,1,3,3-pentaethoxy-1,3-disilapropane, 3-mercaptopropyl trimethoxysilane, 3-mercaptopropyl methyldimethoxysilane, 3-mercaptopropyl triethoxysilane 3-isocyanatopropyl triethoxysilane, tris(3-trimethoxysilylpropyl)isocyanurate, triethoxysilylpropyl ethylcarbamate, trifluoropropyl trimethoxysilane, and allyltriethoxysilane. By way of specific examples and without limitation, the functionalized metalloid sol precursor compound can include, be derived from, or be compounded with any of the following structures:

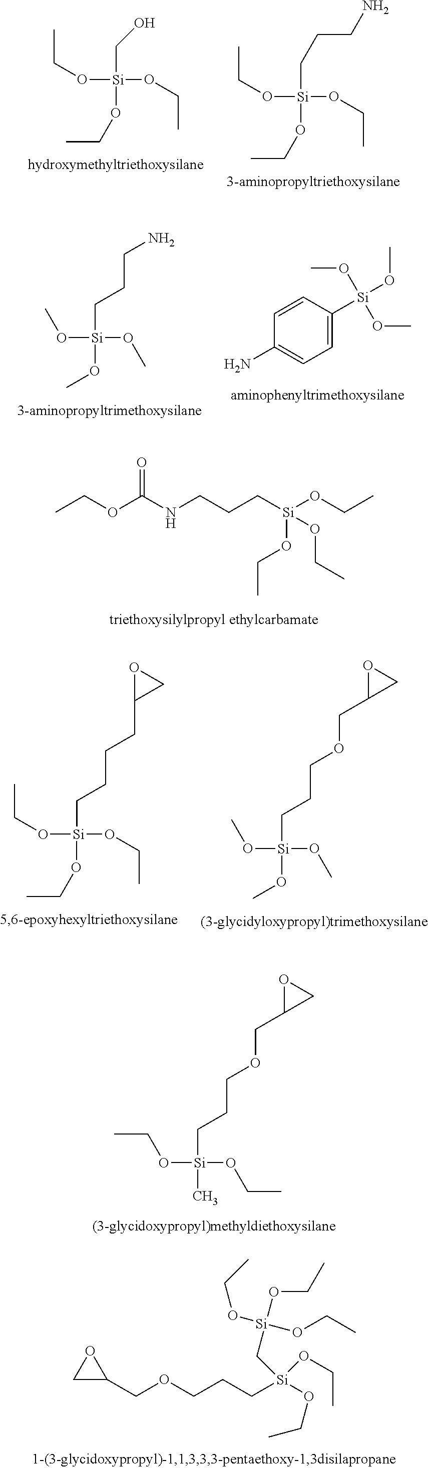

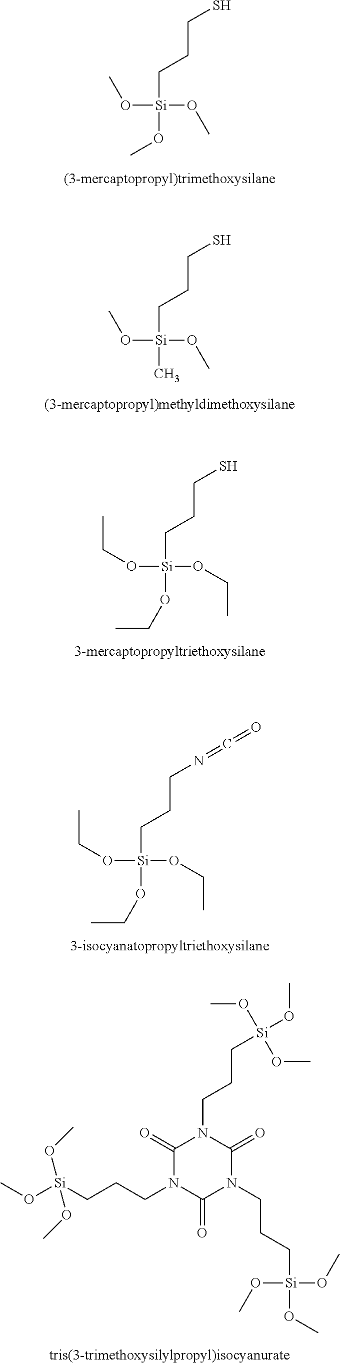

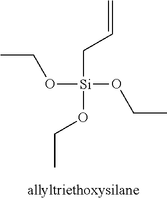

The functionalized metalloid sol precursor compound is added to the solvent mixture to cause the alkoxide ligands in the precursor compound to hydrolyze. In some embodiments, the functional group ligand does not undergo a hydrolysis reaction when added to the solvent mixture. The resulting hydrolyzed functionalized metalloid sol precursor comprises the central metalloid atom, the functional group ligand bonded to the central metalloid atom, and a plurality of hydroxyl group ligands (e.g., up to three hydroxyl group ligands) bonded to the central metalloid atom. In some embodiments, a catalyst (e.g., an acid of a base) can be added to the mixture to ensure that the reaction goes to completion and/or completes in a reasonable amount of time. The mixture is stirred until the hydrolysis reaction has completed. In some embodiments, the mixture is stirred without heating the mixture. In other embodiments, however, the mixture is heated to increase the reaction rate. In some embodiments, after one or more of the alkoxide ligands have hydrolyzed, some of the hydrolyzed functionalized metalloid sol precursor compound molecules in the first transition metal sol can undergo a polycondensation reaction to form solid-phase nanoparticles of metalloid oxide that include metalloid atoms bonded to oxygen atoms. In some embodiments, the functional group ligands do not participate in the condensation reaction and remain bonded to the central metalloid atom.

Still referring to FIG. 6, at block 612, the first transition metal sol, the second transition metal sol, the metalloid sol, and the functionalized metalloid sol are mixed together to form a sol mixture. In some embodiments, the sol mixture is stirred for 1 to 3 hours at 5-100 RPM. In some embodiments, all of the sols can be added together simultaneously. In other embodiments, some of the sols can be mixed together first and then the other sols can be mixed in afterwards.

In some embodiments, after mixing the sols together, the hydrolyzed sol precursors can undergo a polycondensation reaction whereby the hydrolyzed sol precursors from each of the different sols can bond together to form a network of solid-phase oxide nanoparticles suspended in a solvent solution. As described above in connection with FIG. 5, in a polycondensation reaction, a polymer chain (or network) is formed when different species bond together via condensation reactions. Accordingly, mixing the hydrolyzed sol precursors together can cause the central transition metal atoms and the central metalloid atoms from each of the sols to bond together (via shared oxygen atoms) to form nanoparticles of transition metal/metalloid oxides. For example, when a molecule of the hydrolyzed first transition metal sol precursor compound X(OH)₄ interacts with a molecule of the hydrolyzed metalloid sol precursor compound M(OH)₄, the two molecules can bond together (via a shared oxygen atom) and release a water molecule (H₂O). More specifically, one of the hydroxyl group ligands bonded to the transition metal atom X can react with one of the hydroxyl group ligands bonded to the metalloid atom M, resulting in a water molecule being released and the two central atoms X, M both being single-bonded to the remaining oxygen atom, without being bound to any theory, according to the following reaction:

X(OH)₄+M(OH)₄→(OH)₃X—O-M(OH)₃+H₂O

Afterwards (or simultaneously) the other hydroxyl groups attached to the central atoms X, M can also react with the hydroxyl group ligands from other hydrolyzed sol precursor compounds within the mixture. For example, each of the central transition metal atoms from the first and second transition metal sols can bond to a plurality of other central atoms, e.g. four other central atoms, (via shared oxygen atoms) and each of the metalloid atoms from the metalloid sol can bond to a plurality of other central atoms, e.g., four other central atoms, (via an oxygen atom). While the hydroxyl group ligands bonded to each of the central metalloid atoms in the functionalized metalloid sol do participate in the condensation reaction, the functional group ligands bonded to the central metalloid atoms typically do not participate in the condensation reaction. Accordingly, each of the central metalloid atoms from the functionalized metalloid sol can bond to three other central atoms (via an oxygen atom) while remaining bonded to the functional group ligand. As the polycondensation reaction proceeds, the transition metal atoms, metalloid atoms, and oxygen atoms bond together to form a network oxide material, which is a solid-phase ceramic material. This reaction occurs spontaneously throughout the sol such that many oxide particles are present in the sol. However, this reaction tends to be energetically and/or kinetically unfavorable at room temperatures (e.g., at temperatures between 10° C. and 30° C.), and the reaction rate may be slow, resulting in relatively small solid-phase particles. For example, in some embodiments, the oxide particles can be nanoparticles having a diameter between 1 μm and 20 μm.

As described elsewhere in the specification, in some embodiments, some of the hydrolyzed sol precursor compound molecules in one or more of the prepared sols can bond with other precursor compounds within the sol before the sols are mixed together, resulting in the formation of either transition metal oxide particles or metalloid oxide particles. In these embodiments, after mixing the prepared sols together, these oxide particles can also react with the hydrolyzed sol precursor compounds or other oxide particles within the mixture to form larger oxide particles that can include both transition metal atoms and metalloid atoms.

Still referring to FIG. 6, at block 614, the sol mixture is modified to provide the coating with desired properties. For example, in some embodiments, the bonding interaction (e.g., the hydrophilic-lipophilic balance) of the sol mixture can be tuned by adding one or more surfactants to the sol mixture, which can tune the surface energy of the nanoceramic coating. In some embodiments, the sol mixture can be modified to create a hybrid organic/inorganic network, to covalently bond a dye to the polymerized backbone, to improve ion exchange, to improve elasticity of the nanoceramic coating, to improve corrosion resistance of the nanoceramic coating, and/or to improve heat resistance.

Several different modification techniques can be used to modify the sol mixture. For example, in some embodiments, the sol mixture can be modified using grafting. In these embodiments, the sol mixture is modified by adding one or more chelating agents to the sol mixture. The chelating agents comprise reactive end groups (e.g., hydroxyl or amine groups) that are configured to bond with the functional groups on the polymer backbone that are attached to the metalloid atoms from the functionalized metalloid sol. In this way, adding the chelating agent modifies the sol mixture because the chelating agent grafts onto the polymer backbone of the sol mixture. The chelating agents also include ligands that are configured to coordinate with transition metal atoms added to the sol mixture. Accordingly, modifying the sol mixture via grafting also comprises adding one or more transition metals to the sol mixture. The chelating agents forms a coordinate bond with the added transition metal, thereby bonding the added transition metal to the polymer backbone. Bonding the transition metal to the polymer backbone can improve robustness of the resulting nanoceramic coating by improving the corrosion resistance and/or the adhesion strength of the layer. In some embodiments, chelating specific transition metals to the polymer backbone can change the color of the nanoceramic coating, which can be useful in determining whether the nanoceramic coating has been properly coated onto the substrate and/or when determining the nanoceramic coating failed during fault analysis studies. Examples of suitable chelating agents include diaminobenzoic acid, 3,6-di-2-pyridyl-1,2,4,5-tetrazine, oxalic acid, deferoxamine, acetylacetone, ethylenediaminetetraacetic acid, d-penicillamine, 1-hydroxyethane-1,1-diphosphoric acid, dimercpatopropanol, salicyclic acid, di-2-pyridyl ketone, pyridine-2-carbaldehyde, dibenzo-18-crown-6, 1-aza-18-crown-6, and 2-aminomethyl-15-crown-5. Examples of suitable transition metals that can be added to modify the sol mixture include copper, cobalt, manganese, zinc, titanium, and zirconium. By way of specific examples and without limitations, the chelating agent can include, be derived from, or be compounded with any of the following structures:

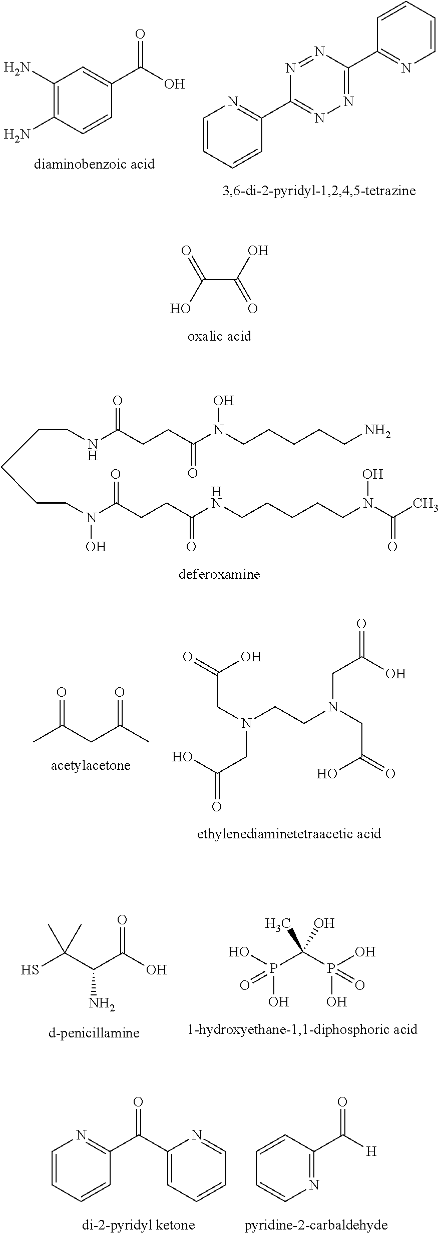

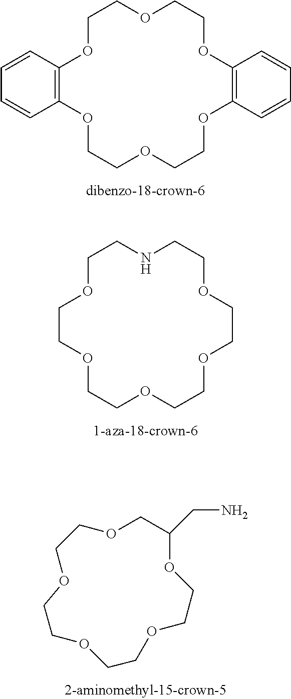 [SMILES: c1ccc2c(c1)OCCOCCOc1ccccc1OCCOCCO2 ; C1COCCOCCOCCOCCOCCN1 ; NCC1COCCOCCOCCOCCO1]

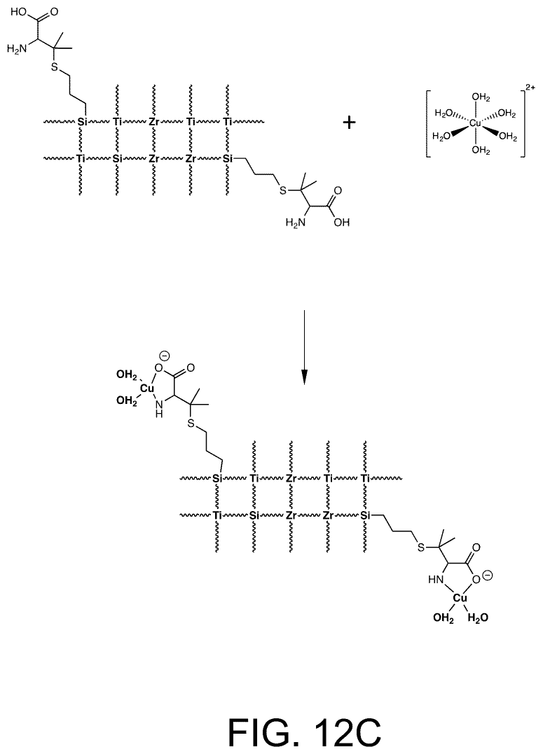

In addition to grafting, several other modification techniques can be used modify the sol mixture. For example, in some embodiments, thiol-ene reactions, schif-base reactions, free-radical, condensation, and click chemistry can be utilized to modify the sol mixture. For example, FIGS. 12A-12C illustrate the formation of a sol mixture and then modification of the sol mixture using thiol-ene chemistry according to embodiments of the present technology. As shown in FIG. 12A, a metalloid sol precursor compound, two transition metal sol precursor compounds, and a functionalized metalloid sol precursor compound can be mixed together to form a polymerized backbone. In the embodiment shown in FIG. 12A, by way of example, the metalloid sol precursor compound is tetraethyl orthosilicate, the two transition metal sol precursor compounds are titanium butoxide and zirconium isopropoxide, the functionalized metalloid sol precursor compound is allyltriethoxysilane, and the polymerized backbone includes silicon, titanium, and zirconium atoms and also includes allyl ligands bonded to some of the terminal silicon atoms. In other embodiments, however, other precursor compounds can be used.

As shown in FIG. 12B, after forming the polymerized backbone, the backbone can then be modified using thiol-ene chemistry by adding a chelating agent. In the embodiment shown in FIG. 12B, the chelating agent is d-penicillamine. In this specific reaction, the sulfur atom in the d-penicillamine bonds to the allyl group, resulting in the d-penicillamine being bonded to some of the silicon atoms in the polymerized backbone. In other embodiments, however, a different chelating agent can be used.

As shown in FIG. 12C, after adding the chelating agent, a compound that includes a transition metal is added. In the embodiment shown in FIG. 12C, the transition metal compound is an aqueous copper complex. In this specific reaction, the copper atoms from the aqueous copper complex bond between the amine and the carboxylic acid groups on the d-penicillamine to form the sol. In other embodiments, however, other transition metal compounds can be added and the other transition metal compounds can react with the chelating agent in a different way.

Still referring to FIG. 6, in the illustrated embodiment, the sol mixture is modified after mixing the transition metal sols, the metalloid sol, and the functionalized metalloid sol together. In other embodiments, however, the modification process can be performed before the sols are mixed together. For example, in embodiments where the sol mixture is modified using a chelating agent and a transition metal, the chelating agent can be added to the functionalized metalloid sol before the functionalized metalloid sol is mixed with the transition metal sols and the metalloid sol. In some embodiments, the chelating agent can be added to the functionalized metalloid sol after the functionalized metalloid sol is formed (e.g., after forming the functionalized metalloid sol in block 610 but before mixing the transition metal sols, the metalloid sol, and the functionalized metalloid sol together in block 612). In other embodiments, however, the chelating agent can be added during the formation of the functionalized metalloid sol. For example, in some embodiments, the chelating agent is added to the solvent mixture before, during, or immediately after the functionalized metalloid sol precursor compound is added to the solvent mixture. In some embodiments, the transition metal that is used to modify the sol mixture is also added to the functionalized metalloid sol before the functionalized metalloid sol is mixed with the transition metal sols and the metalloid sol. For example, in some embodiments, the transition metal is added before, during, or immediately after the chelating agent is added. In other embodiments, however, the transition metal is only added once the transition metal sols, metalloid sol, and functionalized metalloid sol are mixed together.

In some embodiments, modification of the sol mixture comprises modifying the surface energy of the sol mixture by adding one or more surfactants to the sol mixture. Surfactants are chemical compounds that are configured to reduce the surface tension of a coating. Reducing the surface tension of a coating increases the wettability of the coating, which increases the bonding strength between the coating and the substrate. Adding the surfactants to the sol mixture allows for the surface energy of the final nanoceramic nanoceramic to be tuned by balancing the hydrophobicity and hydrophilicity of the nanoceramic. This can be done through the proper selection of surfactants based on their polar head group, tail length, and tail structure. In some embodiments, the surfactant can also be used to reduce the production of foam, adjust the hydrophilic-lipophilic balance (HLB), and/or modify the charge balance at the interface between the substrate and the nanoceramic coating. Suitable surfactants can include non-ionic, cationic, and anionic surfactants. Examples of suitable surfactants include silicone de-foaming agents, cetyl trimethylammonium bromide (CTAB), polyethylene glycol p-(1,1,3,3-tetramethylbutyl)-phenyl ether (e.g., Triton™ X-100 from Dow Chemical Company®), dioctyl sodium sulfosuccinate (e.g., Pentex® 99 from Solvay®), lauryl betaine, polydimethylsiloxanes, and fluorinated surfactants such as perfluorooctane sulfonate, propenoic acid, 1H,1H,2H,2H-perfluorooctyl isobutyrate, perfluoroalkyl phosphinic acids (1≤X≤10), and hexafluoropropylene oxide trimer acid. By way of specific examples and without limitations, the surfactant can include, be derived from, or be compounded with any of the following structures:

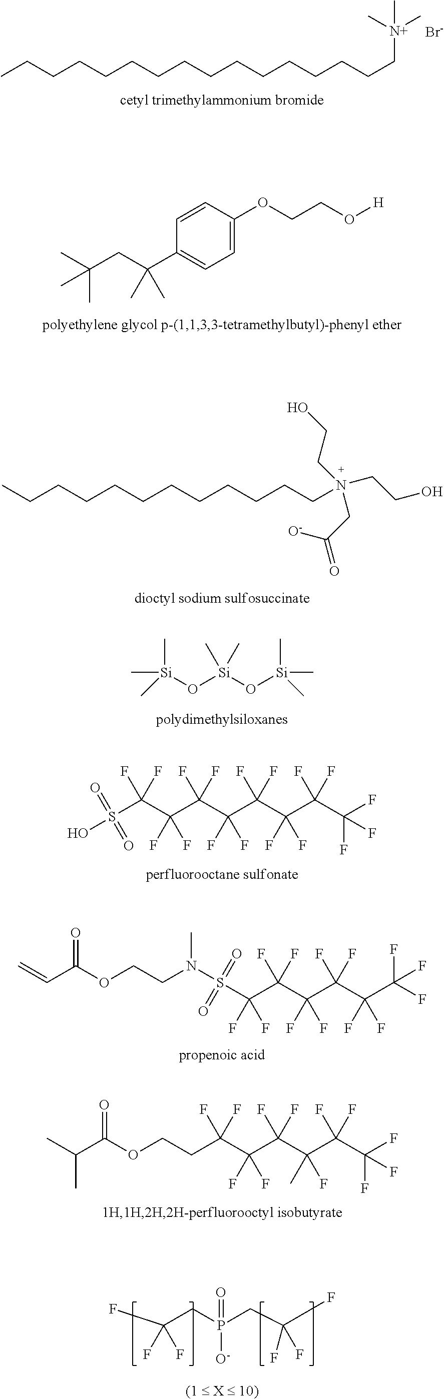

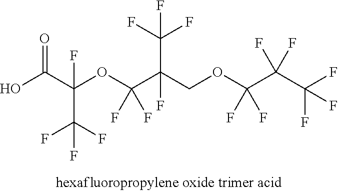 [SMILES: O=C(O)C(F)(OC(F)(F)C(F)(COC(F)(F)C(F)(F)C(F)(F)F)C(F)(F)F)C(F)(F)F]

Still referring to FIG. 6, at block 616, the sol mixture is coated onto the substrate. The sol mixture can be coated onto the substrate using any suitable coating method and the sol coating can have any suitable thickness. For example, the sol mixture can be coated onto the substrate using roll coating, spray coating, or dip coating methods and the resulting layer can have an as-dried or as-cured thickness of thickness between 10 μm and 400 μm, a thickness between 10 μm and 200 μm, a thickness of 10 μm, 20 μm, 40 μm, 60 μm, 80 μm, 100 μm, 120 μm, 140 μm, 160 μm, 180 μm, 200 μm, 240 μm, 280 μm, 320 μm, 360 μm, 400 μm, or a thickness in a range defined by any of these values. In some embodiments, the coating process occurs at ambient temperature.

In some embodiments, the surface of the substrate can be functionalized to have hydroxyl and/or carboxyl groups thereon. These hydroxyl and carboxyl groups can be formed on the substrate during the pre-processing of the substrate. For example, in some embodiments, the substrate goes through a washing step that leaves the hydroxyl and carboxyl groups on the surface. When the sol mixture is coated onto the substrate, the functional groups in the sol mixture (e.g., the functional groups bonded to the metalloid atoms from the functionalized metalloid sol) can bond with the hydroxyl and carboxyl groups at the surface. This bonding between the sol mixture and the substrate can increase the adhesion strength of the nanoceramic coating to the substrate.

At block 618, the coated substrate is heated. Heating the coated substrate causes the reaction rate of the polycondensation reaction to increase, resulting in the solid-phase ceramic particles in the sol mixture to grow and the sol mixture to ceramitize, e.g., form inorganic and non-metallic bonds characteristic of crystalline or amorphous ceramic materials, and form a sol-gel. Heating the coated substrate also causes the water and the other solvents in the sol mixture to evaporate. Other components within the sol mixture, such as organic compounds released during the hydrolysis reactions, can also evaporate during this heating process. Accordingly, after heating the coated substrate, all (or substantially all) of the liquids within the sol mixture have evaporated, leaving behind the nanoceramic coating, which is formed from the solid-phase ceramic particles of metal/metalloid oxide.

In some embodiments, the coated substrate is heated, e.g., using an oven, to a temperature of 180° C. for a time between 50 and 120 seconds. In other embodiments, however, the coated substrate can be heated, e.g., oven-heated, to a different temperature for a different amount of time. For example, in some embodiments, the coated substrate is heated, e.g., oven heated, to a temperature of 100° C., 120° C., 140° C., 160° C., 180° C., 200° C., more than 200° C., or a temperature in a range defined by any of these values, and can be heated for a time of 30 seconds, 60 seconds, 90 seconds, 120 seconds, more than 120 seconds, or a time in a range defined by any of these values.

In some embodiments, blocks 616 and 618 are performed sequentially such that the coated substrate is not heated until after the entire substrate is coated with the sol mixture or the sol-gel. In other embodiments, the coating and heating steps are performed in a continuous process such that portions of the substrate are being coated with the sol mixture while other portions of the substrate, which were previously coated with the sol mixture, are being heated to ceramitize the sol mixture and form the nanoceramic coating on the substrate.

After forming the coated substrate, in some embodiments, an elastomer layer can be formed over the nanoceramic coating. The elastomer layer can be formed by depositing an uncured (or at only partially cured) rubber solution over the nanoceramic coating and then heating the rubber solution to cause the rubber solution to vulcanize and fully cure. In some embodiments, heating the rubber solution can cause the nanoceramic coating to also be heated. This additional heating of the nanoceramic coating can cause any liquid (e.g., water and other solvents) remaining in the nanoceramic coating to evaporate while also causing the ceramic particles to further grow and bond together.

In some embodiments, the elastomer layer can form a strong adhesion bond to the coating formed according to various embodiments described herein. For example, in some embodiments, the elastomer layer can have functionalities that bond with the functional groups in the sol mixture. In some embodiments, the elastomer layer can include one or more additives having functionalities that bond with the functional groups. This bonding can significantly increase the adhesion strength between the elastomer layer and the underlying substrate. That is, the nanoceramic coating can serve as a pretreatment coating to increase the adhesion between the substrate and the overlying elastomer layer, which can improve the functionality of the coated article.

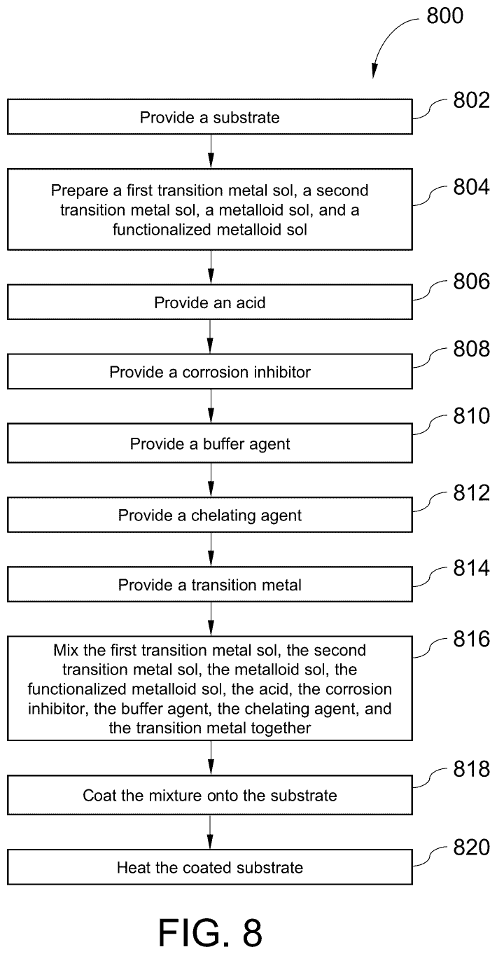

In the embodiments described above in connection with FIGS. 5 and 6, the nanoceramic coating is formed using a sol-gel process whereby one or more sols are formed, mixed together, and then deposited on the substrate before being heated to form a sol-gel nanoceramic coating. According to alternative embodiments, however, the coating, e.g., a pretreatment coating, is formed using a different process. FIG. 7 is a flowchart illustrating an alternative process 700 for forming the nanoceramic coating that involves mixing various compounds together, unlike the method described above with respect to FIG. 6, in which individual sols are prepared separately prior to mixing. At block 702, a substrate is provided. As described above in connection with FIGS. 3 and 4, the substrate can be formed from metal, such as stainless steel, cold rolled steel, galvanized steel, or aluminum. The substrate can be configured to provide structure and support to the nanoceramic coating and any other layers that are subsequently formed over the nanoceramic coating (e.g., a cured elastomer layer). Various aspects providing the substrate may be similar to those described above with respect to FIGS. 3 and 4.

At block 704, a primary alcohol is provided. Primary alcohols are alcohols where the carbon atom of the hydroxyl group is attached to only a single alkyl group. Examples of primary alcohols that can be used include methanol, ethanol, propanol, and butanol.

At block 706, an acid is provided. In some embodiments, the acid comprises an inorganic acid. In other embodiments, the acid comprises an organic acid. Examples of suitable acids include hydrochloric acid, phosphoric acid, sulfuric acid, formic acid, acetic acid, and citric acid.

At block 708, two or more transition metal compounds are provided. The transition metals and/or the transition metal compounds as described herein can be similar to those described above with respect to FIGS. 5 and 6, and some of the detailed description related thereto may be omitted herein for brevity. Transition metals include any element in groups 3 to 12 on the periodic table and can include elements such as Cu, Co, Mn, Zn, Ti, Zr, Ta, Hf, and V. In some embodiments, the two or more transition metal compounds comprise different transition metals. For example, in some embodiments, a first transition metal compound can comprise a first transition metal (e.g., Zr) and a second transition metal compound can comprise a second transition metal that is different form the first transition metal (e.g., Ti). In some embodiments, the two or more transition metal compounds comprise transition metal alkoxides. As described elsewhere in the application, transition metal alkoxides can include a central transition metal atom and a plurality of alkoxide ligands (e.g., four alkoxide ligands) bonded to the central transition metal atom. For example, in embodiments, where the two or more transition metal compounds includes a first transition metal compound that comprises Zr and a second transition metal compound that comprises Ti, the two or more transition metal compounds can include zirconium alkoxide and titanium alkoxide. However, embodiments are not limited to those where the transition metal compounds comprise transition metal alkoxides. Accordingly, in some embodiments, the transition metal compounds can include one or more non-alkoxide ligands bonded to the central transition metal atoms.

At block 710, one or more metalloid compounds are provided. Metalloids are elements whose properties are intermediate between those of metals and those of solid nonmetals or semiconductors and include elements such as Si, B, Ge, and Sb. In some embodiments, the one or more metalloid compounds comprise metalloid alkoxides. As described elsewhere in the application, metalloid alkoxides can include a central metalloid atom and a plurality of alkoxide ligands (e.g., four alkoxide ligands) bonded to the central metalloid atom. However, embodiments are not limited to those where the one or more metalloid compounds comprise metalloid alkoxides. Accordingly, in some embodiments, the one or more metalloid compounds can include one or more non-alkoxide ligands bonded to the central metalloid atoms. In some embodiments, at least one of the one or more metalloid compounds comprises a functionalized metalloid compound having one or more functional group ligands bonded to the central metalloid atom.

In some embodiments, the one or more metalloid compounds comprises a single metalloid compound. In other embodiments, however, the one or more metalloid compounds comprises at least two metalloid compounds. For example, in some embodiments, the one or more metalloid compounds can include a first metalloid compound and a second metalloid compound. In some embodiments, the first and second metalloid compounds can comprise the same central metalloid atom (e.g., Si) but can include different ligands bonded to the central metalloid atom. For example, in embodiments where the first and second metalloid compounds both comprise central Si atoms, the first metalloid compound can comprise tetraethyl orthosilicate and the second metalloid compound can comprise tetramethoxysilane. In other embodiments, however, the first and second metalloid compounds can comprise different central metalloid atoms. In these embodiments, the ligands bonded to the central metalloid atom for the first metalloid compound can be the same ligands as those bonded to the central metalloid atom for the second metalloid compound, or they can be different ligands.

Still referring to FIG. 7, at block 712, a buffer agent is provided. The buffer agent is configured to modify the pH of the mixture after the various compounds are added together. Examples of suitable buffer agents include ammonium bicarbonate, sodium acetate, succinic acid, citric acid, and formic acid. By way of specific examples and without limitations, the buffer agent can include, be derived form, or be compounded with any of the following structures:

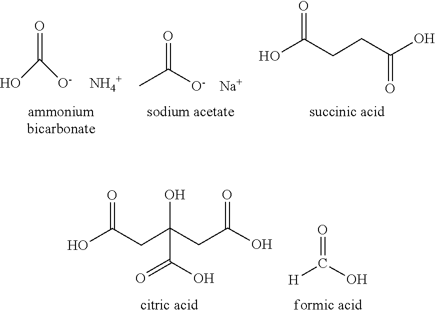

At block 714, a surfactant is provided. The surfactant is configured to reduce the production of foam, adjust the hydrophilic-lipophilic balance (HLB), and/or modify the charge balance at the interface between the substrate and the nanoceramic coating. Examples of suitable surfactants include cetyl trimethylammonium bromide (CTAB), polyethylene glycol p-(1,1,3,3-tetramethylbutyl)-phenyl ether (e.g., Triton™ X-100 from Dow Chemical Company®), aqueous dioctyl sodium sulfosuccinate (e.g., Pentex® 99 from Solvay®), lauryl betaine, polydimethylsiloxanes, and fluorinated surfactants.

At block 716, a dye or pigment is provided. The dye or pigment acts as a colorant for the mixture and is configured to change the color of the final nanoceramic coating. Selectively changing the color of the nanoceramic coating can be useful in determining, e.g., visually without aid of an instrument, whether the nanoceramic coating has been properly coated onto the substrate and/or when determining the nanoceramic coating failed during fault analysis studies. The dyes and pigments can be added so that the coated substrates can have a suitable color for sufficient distinction, e.g., by visual inspection. In some embodiments, the color of coated substrate can be represented using the L*a*b* color space from the international commission on illumination (commonly referred to as the CIELAB color space), which defines the color of an object using a lightness value (L*), a red/green value (a*), and a blue/yellow value (b*). Under the CIELAB color space, a lightness value of 100 corresponds to white while a lightness value of 0 corresponds to black, a positive red/green value indicates that the sample is more red than green while a negative red/green value indicates that the sample is more green than red, and a positive blue/yellow value indicates that the sample is more yellow than blue while a negative blue/yellow value indicates that the sample is more blue than yellow. In some embodiments, dyes and pigments can be added so that the coated substrate can be any color defined by CIELAB measurements of L*: 55 to 75, a*: −20 to 15, b*: −20 to 10 when CIE Standard illuminant D65 is used as the reference white. Examples of suitable pigments include: 2-[[1,3-dioxo-1-[(2-oxo-1,3-dihydrobenzimidazol-5-yl)amino]butan-2-yl]diazenyl]benzoic acid, sodium 4-[[4-(dimethylamino)phenyl]-(4-dimethylazaniumylidenecyclohexa-2,5-dien-1-ylidene)methyl]-3-hydroxynaphthalene-2,7-disulfonate, copper chlorophthalocyanine, 2-[(4-chloro-2-nitrophenyl)diazenyl]-3-oxo-N-(2-oxo-1,3-dihydrobenzimidazol-5-yl)butanamide, sodium 4-[(2-hydroxynaphthalen-1-yl)liazinyl]naphthalene-1-sulfonate, or a suitable mixture thereof to achieve the particular color of interest, e.g., for visual distinction.

At block 718, the primary alcohol, acid, two or more transition metal compounds, one or more metalloid compounds, buffer agent, surfactant, dye/pigment, and water are mixed together. In some embodiments, the mixture is stirred for 10-60 minutes at 10-100 RPM. In some embodiments, all of the compounds are mixed together simultaneously. In other embodiments, a portion of the ingredients are mixed together first before the other ingredients are mixed together. For example, in some embodiments, the two or more transition metal compounds and one or more metalloid compounds are mixed together before they are mixed with the other compounds. In some embodiments, the primary alcohol, acid, and/or buffer agent are mixed together before one or more of the other compounds are mixed together. In general, the compounds can be mixed together in any suitable order or combination and can be mixed for any suitable amount of time.

Mixing the transition metal compounds and metalloid compound(s) with the water, acid, alcohol, and other solvents causes the transition metal compounds and metalloid compound(s) to react with water in the mixture and undergo hydrolysis reactions whereby the ligands attached to the central atoms are replaced by hydroxyl groups. As described above in connection with FIGS. 5 and 6, the resulting hydrolyzed compounds include the central transition metal and metalloid atoms each bonded to a plurality of hydroxyl group ligands (e.g. four hydroxyl group ligands). In some embodiments, mixture can be heated to increase the hydrolysis reaction rate.

At block 720, after mixing the primary alcohol, acid, two or more transition metal compounds, one or more metalloid compounds, buffer agent, surfactant, and dye/pigment together, the mixture is coated onto the substrate. The mixture can be coated onto the substrate using any suitable coating method and the mixture can have any suitable thickness. For example, the mixture can be coated onto the substrate using roll coating, spray coating, or dip coating methods and the resulting layer can have an as-dried or as-cured thickness of thickness between 10 μm and 400 μm, a thickness between 10 μm and 200 μm, a thickness of 10 μm, 20 μm, 40 μm, 60 μm, 80 μm, 100 μm, 120 μm, 140 μm, 160 μm, 180 μm, 200 μm, 240 μm, 280 μm, 320 μm, 360 μm, 400. In some embodiments, the coating process occurs at ambient temperature. As described above in connection with FIG. 6, in some embodiments, the coated mixture can bond with the hydroxyl groups present on the surface of the substrate, which can increase the adhesion strength of the nanoceramic coating to the substrate.

In some embodiments, the mixture is not coated onto the substrate until all (or substantially all) of the transition metal compounds and metalloid compounds have fully hydrolyzed. In other embodiments, the mixture can be coated onto the substrate while some or even most of the transition metal and metalloid compounds have not fully hydrolyzed. In still other embodiments, the substrate can be coated immediately after the mixture is formed such that none (or substantially none) of the transition metal compounds and metalloid compounds have fully hydrolyzed.

As described above in connection with FIGS. 5 and 6, the hydrolyzed transition metal and metalloid compounds can undergo a condensation reaction to form solid-phase oxide nanoparticles. However, this condensation reaction tends to be energetically unfavorable at room temperatures. Accordingly, at block 722, the coated substrate is heated to cause the hydrolyzed compounds to undergo the polycondensation reaction and form the solid-phase oxide nanoparticles. Heating the coated substrate can also cause any of the unhydrolyzed transition metal and metalloid compounds in the mixture to hydrolyze and then undergo the condensation reactions and can also cause any liquids in the mixture (e.g., water, primary alcohol) to evaporate. Accordingly, after heating the coated substrate, all (or substantially all) of the liquid within the mixture have evaporated, leaving behind the nanoceramic pretreatment coating, which is formed from the solid-phase ceramic particles of metal/metalloid oxide.

In some embodiments, the coated substrate is heated, e.g., using an oven, to a temperature between 150° C. and 190° C. for a time between 50 seconds and 120 seconds. In other embodiments, however, the coated substrate can be heated, e.g., oven-heated, to a different temperature for a different amount of time. For example, in some embodiments, the coated substrate is heated, e.g., oven-heated, to a temperature of 100° C., 120° C., 140° C., 160° C., 180° C., 200° C., more than 200° C., or a temperature in a range defined by any of these values, and can be heated for a time of 30 seconds, 60 seconds, 90 seconds, 120 seconds, more than 120 seconds, or a time in a range defined by any of these values.

Still referring to FIG. 7, in some embodiments, blocks 720 and 722 are performed sequentially such that the coated substrate is not heated until after the entire substrate is coated with the mixture. In other embodiments, the coating and heating steps are performed in a continuous process such that portions of the substrate are being coated with the mixture while other portions of the substrate, which were previously coated with the mixture, are being heated to ceramitize the mixture and form the nanoceramic coating on the substrate.

In some embodiments, the coating described herein serves as a pretreatment coating. In these embodiments, after forming the coated substrate, in some embodiments, an elastomer layer can be formed over the nanoceramic pretreatment coating. The elastomer layer can be formed by depositing an uncured (or at only partially cured) rubber solution over the nanoceramic pretreatment coating and then heating the rubber solution to cause the rubber solution to vulcanize and fully cure. In some embodiments, heating the rubber solution can cause the nanoceramic pretreatment coating to also be heated. This additional heating of the nanoceramic pretreatment coating can cause any liquid (e.g., water, alcohol, acid) remaining in the nanoceramic pretreatment coating to evaporate while also causing the ceramic particles to further grow and bond together.

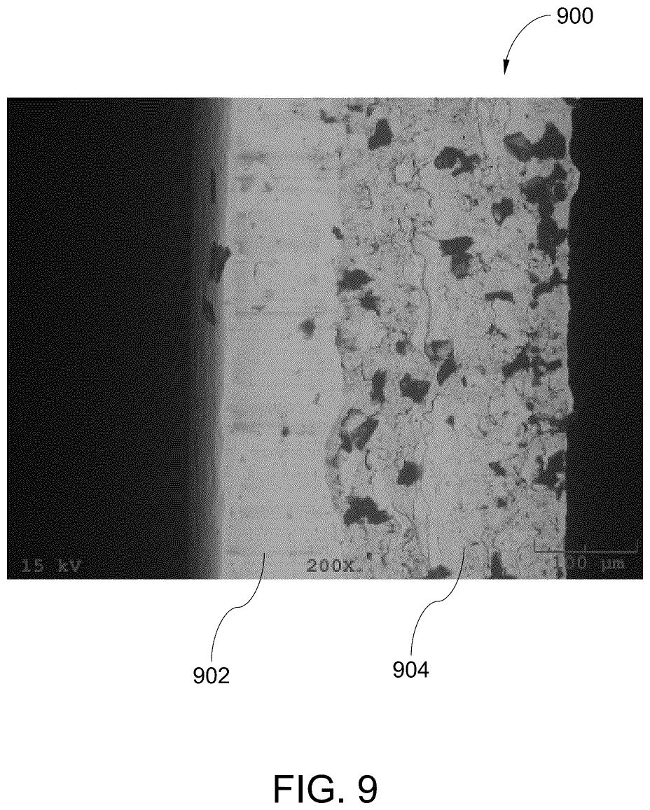

FIG. 8 is a flowchart illustrating another alternative process 800 for forming a coating, e.g., a nanoceramic pretreatment coating, that involves blending the sol-gel process described above in connection with FIGS. 5 and 6 with some aspects of the mixing process described above in connection with FIG. 7. At block 802, a substrate is provided. As described above in connection with FIGS. 3 and 4, the substrate can be formed from metal, such as stainless steel, cold rolled steel, galvanized steel, or aluminum. The substrate can be configured to provide structure and support to the coating and any other layers that are subsequently formed over the coating (e.g., a cured elastomer layer). Various aspects providing the substrate may be similar to those described above with respect to FIGS. 3 and 4.

At block 804, a first transition metal sol, a second transition metal sol, a first metalloid sol, and a functionalized metalloid sol can be prepared. The transition metals and/or the transition metal compounds as described herein can be similar to those described above with respect to FIGS. 5 and 6, and some of the detailed description related thereto may be omitted herein for brevity. In some embodiments, the first transition metal sol is prepared according to the methods of FIG. 5 and block 604 of FIG. 6, the second transition metal sol is prepared according to the methods of FIG. 5 and block 606 of FIG. 6, the metalloid sol is prepared according to the methods of FIG. 5 and block 608 of FIG. 6, and the functionalized metalloid sol is prepared according to the methods of FIG. 5 and block 610 of FIG. 6.

At block 806, an acid is provided. The acid is configured to passivate the surface of the substrate to increase the corrosion resistance of the substrate. In some embodiments, the acid comprises a hexafluorometallic acid. Hexafluorometallic acids have a chemical formula of HₙXF₆, where n can be 1 or 2 and X can be Zr, Ti, P, Sb, or Si. In other embodiments, however, the acid can be a different acid, such as acetic acid (CH₃COOH), hydrochloric acid (HCl), nitric acid (HNO₃), phosphoric acid (H₃PO₄), sulfuric acid (HSO₄), and hydrofluoric acid (HF).

At block 808, a corrosion inhibitor is provided. The corrosion inhibitor is configured to slow the corrosion rate or essentially prevent the corrosion of the substrate when present in the sol-gel mixture. Examples of suitable corrosion inhibitors include sodium nitrate, diaminobenzoic acid, and 3,6-di-2-pyridyl-1,2,4,5-tetrazine. By way of specific examples and without limitations, the corrosion inhibitor can include, be derived form, or be compounded with any of the following structures:

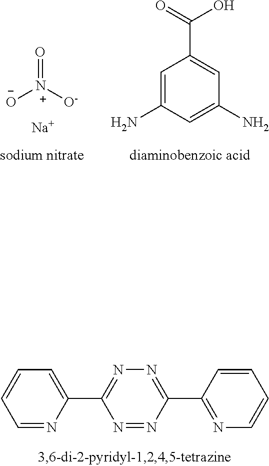

At block 810, a buffer agent is provided. As described above in connection with FIG. 7, the buffer agent is configured to modify the pH of the final mixture. Examples of suitable buffer agents include ammonium bicarbonate, sodium acetate, succinic acid, citric acid, and formic acid.

At block 812, a chelating agent is provided. As described above in connection with FIG. 6, the chelating agents are configured to modify the functionalized metalloid sol. The chelating agents comprise reactive end groups (e.g., hydroxyl or amine groups) that are configured to bond to the functional groups in the functionalized metalloid sol. The chelating agents can also include ligands that are configured to coordinate with transition metals added to the sol. Examples of suitable chelating agents include diaminobenzoic acid, 3,6-di-2-pyridyl-1,2,4,5-tetrazine, oxalic acid, deferoxamine, acetylacetone, ethylenediaminetetraacetic acid, d-penicillamine, 1-hydroxyethane-1,1-diphosphoric acid, dimercpatopropanol, and salicyclic acid.

At block 814, a transition metal is provided. As described above in connection with FIG. 6, the transition metals are configured to bond to the ligands of the chelating agent to improve the robustness of the resulting nanoceramic coating (e.g., by improving the corrosion resistance and/or the adhesion strength of the layer) and/or to change the color of the nanoceramic coating. Examples of suitable transition metals that can be added to modify the sol include copper, cobalt, manganese, zinc, titanium, and zirconium.

At block 816, the first transition metal sol, the second transition metal sol, the metalloid sol, the functionalized metalloid sol, the acid, the corrosion inhibitor, the buffer agent, the chelating agent, and the transition metal are mixed together. In some embodiments, the mixture is stirred for 10-60 minutes at 10-100 RPM. In some embodiments, all of the ingredients can be mixed together simultaneously. In other embodiments, some of the ingredients can be mixed together first and then the other ingredients can be mixed in afterwards. For example, in some embodiments, the first transition metal sol, the second transition metal sol, the metalloid sol, and the functionalized metalloid sol can be mixed together first, and then the acid, corrosion inhibitor, the buffer agent, the chelating agent, and the transition metal can be mixed in. In some embodiments, the chelating agent can be mixed into the functionalized metalloid sol before the functionalized metalloid sol is mixed with the transition metals sols and the metalloid sol. In some embodiments, the transition metal can also be mixed with the chelating agent and functionalized metalloid sol before functionalized metalloid sol is mixed with the transition metal sols and metalloid sol.

Mixing the sols, the acid, the corrosion inhibitor, the buffer agent, the chelating agent, and the transition metal can cause the hydrolyzed sol precursors in the sols to undergo polycondensation reactions and form solid-phase oxide nanoparticles. However, the polycondensation reactions tends to be energetically and/or kinetically unfavorable at room temperatures (e.g., at temperatures between 10° C. and 30° C.), meaning that the reaction rate may be slow, resulting in relatively small solid-phase particles. Mixing the functionalized metalloid sol with the chelating agent can cause the chelating agent molecules to bond to the functionalized ligands of the functionalized metalloid sol. Additionally, the transition metal atoms added to the blend can react with the bonded chelating agents, resulting in the transitional metal atoms being bonded to the polymer backbone of the solid-phase transition metal/metalloid oxide nanoparticles, which can improve the corrosion resistance, bonding strength, and/or color of the resulting nanoceramic coating.

Still referring to FIG. 8, at block 818, after mixing the first transition metal sol, the second transition metal sol, the metalloid sol, the functionalized metalloid sol, the acid, the corrosion inhibitor, the buffer agent, the chelating agent, and the transition metal together, the mixture is coated onto the substrate. The mixture can be coated onto the substrate using any suitable coating method and the mixture can have any suitable thickness. For example, the mixture can be coated onto the substrate using roll coating, spray coating, or dip coating methods such that, as dried and cured, the layer can have a thickness of 10 μm, 20 μm, 40 μm, 80 μm, 120 μm, 160 μm, 200 μm, 240 μm, 280 μm, 300 μm, or a thickness in a range defined by any of these values. In some embodiments, the coating process occurs at ambient temperature.

As described above in connection with FIGS. 5 and 6, the sols can undergo a condensation reaction to form solid-phase oxide nanoparticles. However, this condensation reaction tends to be energetically unfavorable at room temperatures. Accordingly, at block 820, the coated substrate is heated to cause the hydrolyzed compounds in the sols to undergo the polycondensation reaction and form the solid-phase oxide nanoparticles. Heating the coated substrate can also cause any of any unhydrolyzed transition metal and metalloid compounds in the sols to hydrolyze and then undergo the condensation reactions and can also cause any liquids in the mixture (e.g., water, primary alcohol) to evaporate. Accordingly, after heating the coated substrate, all (or substantially all) of the liquid within the mixture have evaporated, leaving behind the nanoceramic coating, which is formed from the solid-phase ceramic particles of metal/metalloid oxide.

In some embodiments, the coated substrate is heated using an oven heated to a temperature between 150° C. and 190° C. for a time between 50 seconds and 120 seconds. In other embodiments, however, the coated substrate can be heated using an oven heated to a different temperature for a different amount of time. For example, in some embodiments, the coated substrate is heated (e.g., using an oven) to a temperature of 100° C., 120° C., 140° C., 160° C., 180° C., 200° C., more than 200° C., or a temperature in a range defined by any of these values, and can be heated for a time of 30 seconds, 60 seconds, 90 seconds, 120 seconds, more than 120 seconds, or a time in a range defined by any of these values.

In some embodiments, blocks 818, 820 are performed sequentially such that the coated substrate is not heated until after the entire substrate is coated with the mixture. In other embodiments, the coating and heating steps are performed in a continuous process such that portions of the substrate are being coated with the mixture while other portions of the substrate, which were previously coated with the mixture, are being heated to ceramitize the mixture and form the nanoceramic coating on the substrate.

In some embodiments, the nanoceramic coating described herein serves as a pretreatment coating. In these embodiments, after forming the coated substrate, in some embodiments, an elastomer layer can be formed over the pretreatment coating. The elastomer layer can be formed by depositing an uncured (or at only partially cured) rubber solution over the pretreatment coating and then heating the rubber solution to cause the rubber solution to vulcanize and fully cure. In some embodiments, heating the rubber solution can cause the pretreatment coating to also be heated. This additional heating of the pretreatment coating can cause any liquid (e.g., water, alcohol, acid) remaining in the pretreatment coating to evaporate while also causing the ceramic particles to further grow and bond together.

The elemental composition of the nanoceramic coatings formed according to the methods described above in connection with FIGS. 5-8 can depend on the specific precursor compounds and other additives used. In some embodiments, the nanoceramic coating can comprise a ceramic material having carbon, oxygen, at least one metalloid (e.g., Si, Sb), and two or more transition metals (e.g., Cu, Co, Mn, Zn, Ti, Zr, Ta, Hf, V). The nanoceramic coating can comprise additional elements that result from various reactions and processes described above. Some of the reactions or processes may leave characteristic structural modifications. In addition, some of the reactions or processes may be partially completed. For example, in embodiments where hydrofluoric acid is used to form the nanoceramic coating, the resulting nanoceramic coating can include fluorine (F) atoms. Similarly, in embodiments where the phosphoric acid is used and/or where the chelating agent includes phosphorous (e.g., such as when the chelating agent is 1-hydroxyethane-1,1-diphosphoric acid), the resulting nanoceramic coating can include phosphorous (P) atoms. In some embodiments, small or trace amounts of any of the initial, intermediate, or final ingredients (e.g., water, alcohol, acid) may be left behind in the final coatings. In some embodiments, the microstructure of the crystalline material that forms the nanoceramic coating can also be dependent on the specific precursor compounds and additives used to form the layer. For example, the nanoceramic coating can have a crystalline and/or amorphous microstructure and the crystallinity of the nanoceramic coating can be affected by the type and amount of transition metals used to form the nanoceramic coating. Specifically, the crystallinity of the nanoceramic coating can be dependent on the ratio of transition metals used to form the nanoceramic coating. In some embodiments, the crystallinity can also be controlled through the presence of silicon dioxide (SiO₂) and/or by adjusting the thermal processing times (e.g., the temperature at which the coated substrate is heated and/or the amount of time that the coated substrate is heated for). In general, the crystallinity of the nanoceramic coating can be adjusted for the specific application that the coated article is intended to be used for.

### EXPERIMENTAL EXAMPLES

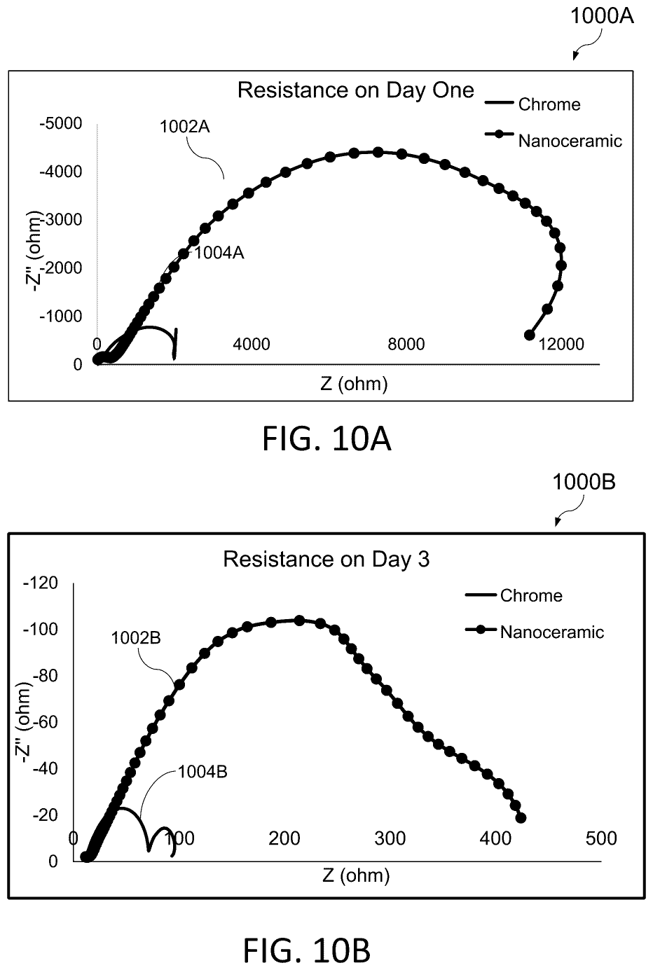

To demonstrate the improved adhesion properties and corrosion resistance of the nanoceramic coating when used as a pretreatment coating, coated articles were formed according to the methods described above in connection with FIGS. 5-8. For example, FIG. 9 shows a cross-sectional view of a coated article 900 taken using scanning electron microscopy (SEM) techniques. The coated article 900 includes a steel substrate 902 and a nanoceramic pretreatment coating 904 formed on the steel substrate 902. The nanoceramic pretreatment coating 904 is strongly adhered to the surface of the bare steel substrate 902 and can have a thickness between 10 μm and 200 μm. An inductively coupled plasma mass spectrometry (ICP-MS) analysis of the formulation used to form this sample showed that zirconium, antimony, manganese, silver, sodium, tin, titanium, and zinc were present. As described above, as deposited on the substrate, the nanoceramic pretreatment coating is initially fluid, e.g., a sol mixture. In addition, a volume fraction of the coating may remain amorphous at least in the initial stages of the heat treatment. Further, the grains of the nanoceramic coating remains smaller than the roughness scales of the substrate. As a result, the coating forms an excellent interface with the underlying substrate surface, with minimal voiding formed therebetween. In addition, the surface roughness of the coating can be substantially lower than that of the underlying substrate. These physical characteristics as well as chemical bond characteristics described above lead to substantially improved adhesion of the overlying elastomeric coating, and corrosion resistance of the underlying substrate.

After forming the sample coated articles, testing was performed on sample coated articles having a pretreatment coating formed according to the methods described above in connection with FIGS. 5-8, as well as on sample coated articles having a chromate conversion coating as comparative examples.

Adhesion testing was performed on samples prepared according to the method described above in connection with FIG. 7 to demonstrate the effectiveness of the nanoceramic pretreatment at ensuring that the elastomer layer remains adhered to the substrate. Three different tests were performed and samples from eight different coated articles were tested for each test. The eight coated articles that were analyzed included four coated articles having a nanoceramic pretreatment coating and four coated articles having a chromate conversion coating. The nanoceramic pretreatment coating was formed according to the process illustrated in FIG. 6 and sol-gel was formed from a mixture having the following composition:

| | |
|---|---|
| distilled water | 50-90 wt. % |
| hexaflurotitanic acid | 5-10 wt. % |
| hexaflurozirconic acid | 0.5-2 wt. % |
| tetraethyl orthosilicate | 1-5 wt. % |
| (3-glycidaloxypropal)trimethoxy silane | 1-5 wt. % |
| 1-hydroxyethane-1,1-diphosphonic acid | 1-5 wt. % |
| cobalt chloride | 0.5-2 wt. % |
| sodium nitirate | 0.01-0.1 wt. % |
| copper sulfate | 0.01-0.1 wt. % |
| ammonium bicarbonate | 0.01-0.5 wt. % |
| silicone defoaming agent | 0.01-0.05 wt. % |
| copper chlorophthalocyanine | 0.1-1 wt. % |

The four coated articles for each type of pretreatment coating differed in their combination of substrate material (e.g., stainless steel or cold rolled steel) and material that the elastomer layer formed over the pretreatment coating is formed on (e.g., non-fluorinated elastomer or fluorinated elastomer). Specifically, the four coated articles tested for each type of pretreatment coating included two having stainless steel substrates and two having cold rolled steel substrates, where the two coated articles for each type of substrate included one having an elastomer layer formed from a non-fluorinated elastomer and one having an elastomer layer formed form a fluorinated elastomer.

First, rub testing was performed to determine the bond adhesion between the substrate and the elastomer layer. For this test, samples of each of the coated articles were partially immersed in methyl ethyl ketone (MEK) for 10 minutes. The samples were then removed from the MEK, wiped dry, and set aside to air dry for 2 minutes. After 2 minutes, a corner of each sample was cut off at about a 45° angle. The cut corner was then rubbed 5 times with hard pressure to see if the elastomer layer would separate from the substrate. A sample is considered to fail this test if the elastomer layer delaminates by more than 0.25 inches from the substrate. Each of the samples tested, including all of the samples having a nanoceramic pretreatment coating, passed this test as the elastomer layers remained sufficiently adhered to the substrate. The rub test was performed a second time (with new samples of the eight different coated articles) but instead of partially submerging the coated article samples in MEK, the samples were each partially immersed in boiling water. All of the samples also passed this second rub test.

Second, crosscut testing was performed to determine bond adhesion. The crosscut tests were performed according to the method described in ASTM D3359. Each of the samples tested, including all of the samples having a nanoceramic pretreatment coating, passed this test as none of the crosshatched elastomer layer delaminated from the substrates. The crosscut testing was then performed again with samples that had been heat aged. In these tests, prior to crosshatching the elastomer layer, the entire sample was aged for 200 hours in Ford 50/50 coolant (a mixture of coolant and deionized water) heated at reflux temperature. Each of the heat-aged samples tested also passed the test without showing any signs of the elastomer layer delaminating.

Third, a stub pull adhesion test was performed according to ASTM D4541 to determine the pull-off strength of the elastomer layer. For each of the coated articles, three different samples were tested under different heat-aging conditions: an initial sample, a sample that had been immersed in Prestone® coolant for two weeks at 130° C., and a sample that had been immersed in Dexos® oil for one week at 150° C. A sample is considered to pass this test if the pull-off strength of the elastomer is at least 1.5 MPa. The results of the stub pull adhesion test for the various samples are shown below in Table 1.

TABLE 1
ASTM D4541 STUB PULL ADHESION TESTS

| | | | | Coolant | Oil |
|---|---|---|---|---|---|
| | | | Initial | Immersion | Immersion |
| Substrate | Elastomer | Pretreatment | (MPa) | (MPa) | (MPa) |
| Stainless | NBR | Nanoceramic | 9.87 | 8.20 | 7.83 |
| Steel | NBR | Chrome | 9.40 | 7.93 | 7.94 |
| | FKM | Nanoceramic | 3.95 | 2.94 | 3.30 |
| | FKM | Chrome | 3.68 | 2.60 | 3.15 |
| | NBR | Nanoceramic | 9.30 | 8.78 | 7.06 |
| | NBR | Chrome | 9.59 | 9.20 | 7.75 |
| Cold | FKM | Nanoceramic | 5.87 | 5.05 | 5.44 |
| Rolled | FKM | Chrome | 6.30 | 4.93 | 5.28 |
| Steel | | | | | |

The results of the three different adhesion tests show that the nanoceramic pretreatment coating is just as effective at ensuring that the elastomer layer remains adhered to the substrate as the chromate conversion coating is and, in some tests, even resulted in greater adhesion.

Corrosion resistance testing of the nanoceramic pretreatment coating was also performed using electrochemical impedance spectroscopy (EIS). In EIS, a coated article is immersed in an aqueous solution for an extended period of time, along with a reference electrode and a counter electrode. An electrical current is established between the coated article and the counter electrode and the impedance of the circuit is measured over time. In general, a higher impedance value indicates a higher corrosion resistance. The durability of the corrosion resistance layer can be measured by running the current through the electrochemical cell for an extended period of time and seeing how the impedance changes.

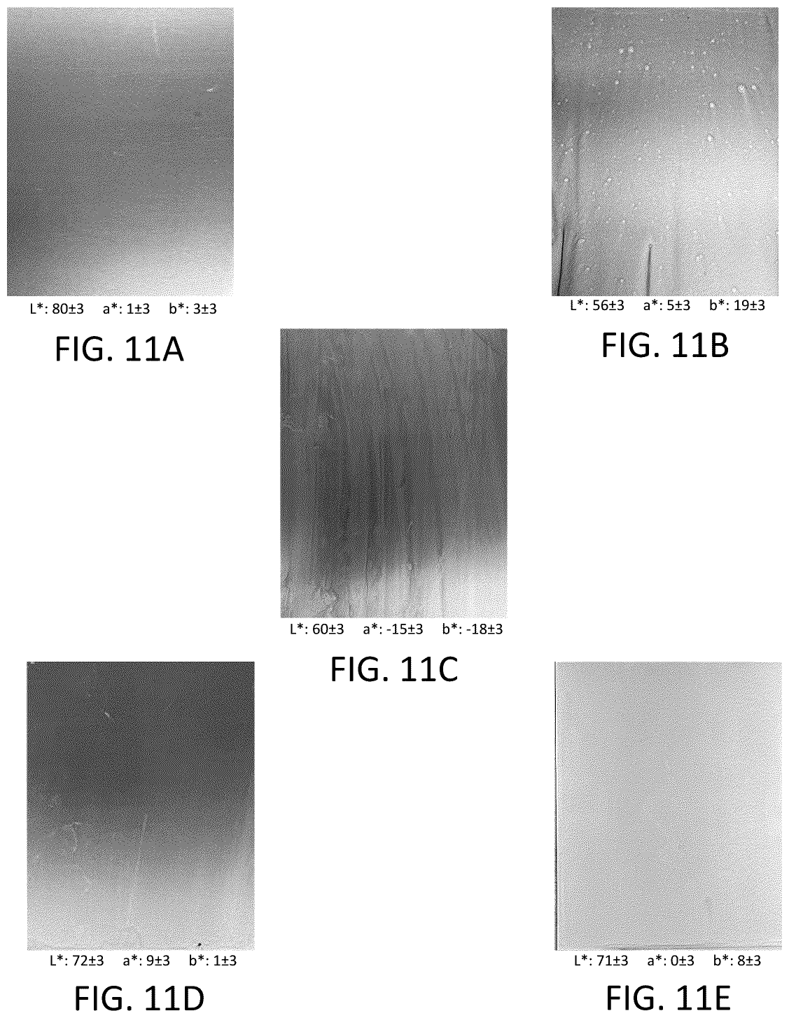

To demonstrate the improved corrosion resistance of the nanoceramic pretreatment coating, first and second coated article samples were prepared and EIS was performed on both samples. The first coated article sample was formed from a substrate and a nanoceramic pretreatment coating (e.g., a nanoceramic pretreatment coating prepared according to the methods described above in connection with FIGS. 5-8) formed on the substrate and the second coated article sample was formed from a substrate and a chromate conversion coating formed on the substrate. The electrochemical cells used to perform the EIS analysis had aqueous solutions of 1M sodium chloride and the first and second samples were left in their respective electrochemical cells for three days, with impedance measurements being taken on the first day and again on the third day. FIGS. 10A and 10B are graphs of Nyquist plots showing the impedances of the first and second samples measured on the first day (FIG. 10A) and the third day (FIG. 10B). A Nyquist plot plots the real impedance measurement, measured in ohms, on the x-axis and the imaginary resistance, also measured in ohms, on the y-axis, where a curve having a larger radius has a higher corrosion resistance than a curve having a smaller radius.

FIG. 10A illustrates a graph 1000A of first and second Nyquist plots 1002A, 1004A showing the impedances of the first and second coated article samples measured on the first day. The Nyquist plot 1002A for the first coated article sample, which has the nanoceramic pretreatment coating, has a radius about six times larger than that of the Nyquist plot 1004A for the second coated article sample, which has the chromate conversion coating. This indicates that the nanoceramic pretreatment coating is 6 times as efficient at negating the corrosion as the chromate conversion coating.

FIG. 10B illustrates a graph 1000B of first and second Nyquist plots 1002B, 1004B showing the impedances of the first and second coated article samples measured on the third day. Graph 1000B shows that the radii for the Nyquist plots 1002B, 1004B from the third day are substantially smaller than the radii for the Nyquist plots 1002A, 1004A from the first day. For example, the maximum real impedance measured for the sample having nanoceramic pretreatment coating was greater than 12,000 ohms on the first day but was only about 410 ohms on the third day. Similarly, the maximum real impedance measured for the sample having the chromate conversion coating decreased from around 2000 ohms on the first day to around 100 ohms on the third day. A similar decrease was also observed in the imaginary impedance measurements. The reduced impedance values indicate that both pretreatment coatings indicates that the aqueous sodium chloride solution did at least partially corrode both pretreatment coatings and was able to contact the metal substrate on which the pretreatment coatings were formed. However, the Nyquist plot 1002B for the first coated article sample has a radius that is at least four times larger than that of the Nyquist plot 1004B for the second coated article sample. This indicates that the nanoceramic pretreatment coating was more effective at resisting corrosion by the sodium chloride aqueous solution than the chromate conversion coating.

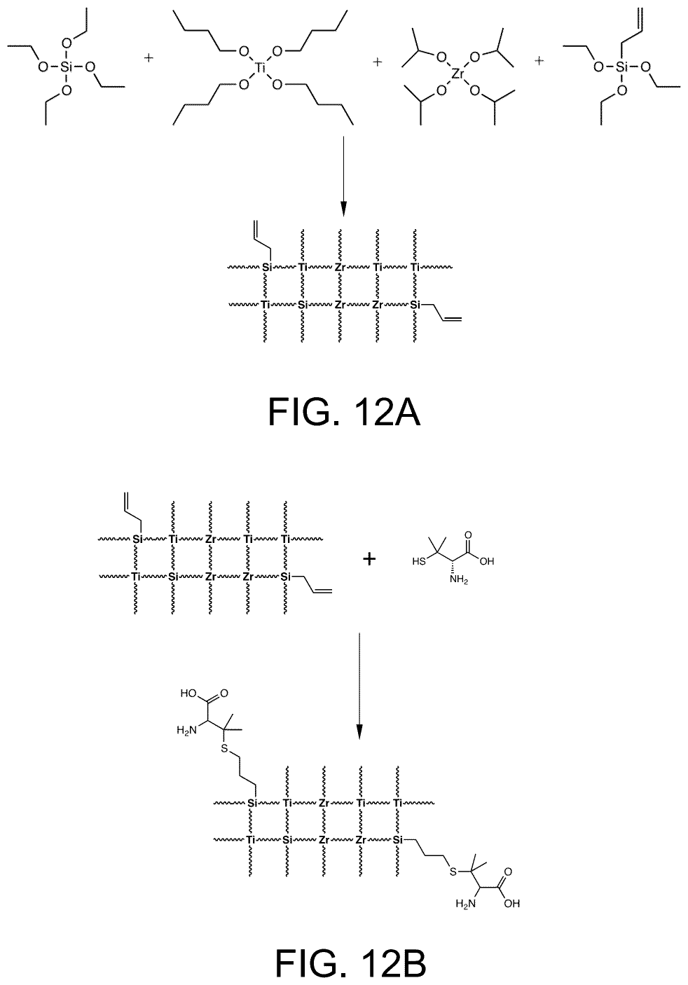

Colorimetry testing was also performed to demonstrate the effectiveness of adding dyes or pigments to the nanoceramic pretreatment coating to change the color of the underlying metal substrate. As discussed in greater detail elsewhere in the specification, selectively changing the color of the nanoceramic coating can be useful in determining whether the nanoceramic coating has been properly coated onto the substrate and/or when determining the nanoceramic coating failed during fault analysis studies. Testing was performed on five different samples: a bare stainless steel sample, a sample having a chrome conversion coating, and three samples having nanoceramic pretreatment coatings. The three samples having nanoceramic pretreatment coatings were prepared according to the method described above in connection with FIG. 7 and the sol-gels used to form these coatings were otherwise the same except that each sol-gel included a different pigment. The three different pigments included a first pigment intended to change the color of the underlying substrate blue, a second pigment intended to change the color of the underlying substrate red, and a third pigment intended to change the color of the underlying substrate yellow. FIGS. 11A-11E are images of the five samples, where FIG. 11A is an image of the bare stainless steel sample, FIG. 11B is an image of the sample having a chrome conversion coating, FIG. 11C is an image of the sample having the pigment intended to turn the substrate blue, FIG. 11D is an image of the sample having the pigment intended to turn the substrate red, and FIG. 11E is an image of the sample having the pigment intended to turn the substrate yellow. The color of the five different samples were then analyzed according to ASTM E1347, in which the CIELAB values (e.g., the L*, a*, and b* values) were determined. The results of the colorimetry test are shown in Table 2.

TABLE 2
ASTM E1347 COLORIMETRY TESTS

| Sample | Color | L* | a* | b* |
|---|---|---|---|---|
| Bare stainless steel | Silver | 80 ± 3 | 1 ± 3 | 3 ± 3 |
| Chrome Conversion | Gold | 56 ± 3 | 5 ± 3 | 19 ± 3 |
| Coating | | | | |
| Blue Pigment | Light blue | 60 ± 3 | −15 ± 3 | −18 ± 3 |
| Red Pigment | Light red/pink | 72 ± 3 | 9 ± 3 | 1 ± 3 |
| Yellow Pigment | Light yellow | 71 ± 3 | 0 ± 3 | 8 ± 3 |

The results of this test show indicate that the nanoceramic pretreatment coating successfully changed the color of the underlying stainless steel substrate. Additionally, different pigments were all effective at changing the color of the substrate.

### Additional Examples

1. A method of forming a coated article, the method comprising:
   providing a metal substrate;
   preparing a sol mixture for forming a ceramic coating, wherein preparing the sol mixture comprises:
      preparing a first transition metal sol that includes a first transition metal;
      preparing a second transition metal sol that includes a second transition metal that is different from the first transition metal;
      preparing a metalloid sol that includes a metalloid; and
      mixing the first transition metal sol, the second transition metal sol, and the metalloid sol together;
   depositing the sol mixture onto a surface of the metal substrate; and
   heating the metal substrate and the sol mixture to form the ceramic coating.
2. The method of Example 1, wherein preparing the first transition metal sol comprises:
   providing a transition metal sol precursor compound comprising the first transition metal;
   providing a solvent; and
   mixing the transition metal sol precursor compound into the solvent.
3. The method of Example 2, further comprising:
   providing a catalyst; and
   mixing the catalyst into the solvent with the transition metal sol precursor compound.
4. The method of Example 3, wherein the catalyst comprises an acid.
5. The method of Example 3, wherein the catalyst comprises a base.
6. The method of Example 2, wherein the transition metal sol precursor compound comprises a transition metal alkoxide having at least two alkoxide ligands bonded to the first transition metal.
7. The method of Example 2, wherein the transition metal sol precursor compound comprises a first transition metal sol precursor compound and the solvent comprises a first solvent, wherein preparing the second transition metal sol comprises:
   providing a second transition metal sol precursor compound comprising the second transition metal;
   providing a second solvent; and
   mixing the second transition metal sol precursor compound into the second solvent.
8. The method of Example 7, wherein the second transition metal sol precursor compound comprises a transition metal alkoxide having at least two alkoxide ligands bonded to the second transition metal.
9. The method of Example 7, wherein each of the first transition metal and the second transition metal is selected from the group consisting of copper (Cu), cobalt (Co), manganese (Mn), zinc (Zn), titanium (Ti), zirconium (Zr), tantalum (Ta), hafnium (Hf) and vanadium (V).
10. The method of Example 9, wherein the first transition metal or the second transition metal is Ti and wherein the corresponding first or second transition metal precursor compound is selected from the group consisting of titanium butoxide, titanium isopropoxide, and titanium chloride.
11. The method of Example 9, wherein the first transition metal or the second transition metal is Zr and wherein the corresponding first or second transition metal precursor compound is elected from the group consisting of zirconium butoxide, zirconium, isopropoxide, zirconium propoxide, and zirconium chloride.
12. The method of Example 1, wherein preparing the metalloid sol comprises:
   providing a metalloid sol precursor compound comprising the metalloid;
   providing a solvent; and mixing the metalloid sol precursor compound into the solvent.
13. The method of Example 12, wherein the metalloid sol precursor compound comprises a metalloid alkoxide having at least two alkoxide ligands bonded to the metalloid.
14. The method of Example 12, wherein the metalloid is selected from the group consisting of silicon (Si), boron (B), germanium (Ge), and antimony (Sb).
15. The method of Example 14, wherein the metalloid is Si and the metalloid sol precursor compound is selected from the group consisting of tetraethyl orthosilicate, tetra-n-propoxysilane, and tetramethoxy silane.
16. The method of Example 1, wherein preparing the sol mixture further comprises:
   preparing a functionalized metalloid sol; and
   mixing the functionalized metalloid sol with the first transition metal sol, the second transition metal sol, and the metalloid sol.
17. The method of Example 16, wherein preparing the functionalized metalloid sol comprises:
   providing a functionalized metalloid sol precursor compound comprising a metalloid atom, one or more alkoxide ligands, and a functional group ligand;
   providing a solvent; and
   mixing the functionalized metalloid sol precursor compound and the solvent.
18. The method of Example 17, wherein the functionalized metalloid sol precursor compound comprises a silane.
19. The method of Example 17, wherein the functionalized metalloid sol precursor compound is selected from the group consisting of hydroxymethyl triethoxysilane, 3-aminopropyl triethoxysilane, 3-aminopropyl trimethoxysilane, aminophenyl trimethoxysilane, 5,6-epoxyhexyl triethoxysilane, 3-glycidoxyoctyl trimethoxysilane, (3-glycidoxy propyl)methyldiethoxysilane, 1-(3-glycidoxypropyl)-1,1,3,3-pentaethoxy-1,3-disilapropane, 3-mercaptopropyl trimethoxysilane, 3-mercaptopropyl methyldimethoxysilane, 3-mercaptopropyl triethoxysilane 3-isocyanatopropyl triethoxysilane, tris(3-trimethoxysilylpropyl)isocyanurate, triethoxysilylpropyl ethylcarbamate, and trifluoropropyl trimethoxysilane.
20. The method of Example 17, wherein the functional group ligand comprises an epoxy functional group, an isocyanate functional group, or an amine functional group.
21. The method of Example 1, wherein the metal substrate comprises a steel.
22. The method of Example 21, further comprising coating the article with an elastomer.
23. The method of Example 22, wherein the article is a brake shim.
24. The method of Example 1, wherein heating the substrate and the sol mixture to form the ceramic coating comprises forming ceramic grains having an average grain size of 1-20 μm.
25. A method of coating a metal substrate, the method comprising:
   forming a sol mixture, wherein forming the sol mixture comprises:
      forming a first transition metal sol from a first transition metal alkoxide;
      forming a second transition metal sol from a second transition metal alkoxide that is different from the first transition metal alkoxide;
      forming a metalloid sol from a metalloid alkoxide; and
      mixing the first transition metal sol, the second transition metal sol, and the metalloid sol together; and
   depositing the sol mixture onto the metal substrate.
26. The method of Example 25, further comprising:
   after depositing the sol mixture onto the metal substrate, heating the coating and the metal substrate.
27. The method of Example 25, wherein the first transition metal alkoxide comprises a first transition metal and wherein the second transition metal alkoxide comprises a second transition metal that is different from the first transition metal.
28. The method of Example 25, wherein forming the first transition metal sol comprises:
   mixing the first transition metal alkoxide with a solvent mixture and a catalyst.
29. The method of Example 28, wherein the solvent mixture comprises a primary alcohol and water.
30. The method of Example 25, wherein forming the sol mixture further comprises:
   forming a functionalized metalloid sol from a functionalized metalloid alkoxide; and
   mixing the functionalized metalloid sol with the first transition metal sol, the second transition metal sol, and the metalloid sol.
31. The method of Example 30, wherein forming the sol mixture further comprises:
   providing a chelating agent; and
   mixing the chelating agent with first transition metal sol, the second transition metal sol, the metalloid sol, and the functionalized metalloid sol.
32. The method of Example 31, wherein the chelating agent is selected from the group consisting of diaminobenzoic acid, 3,6-di-2-pyridyl-1,2,4,5-tetrazine, oxalic acid, deferoxamine, acetylacetone, ethylenediaminetetraacetic acid, d-penicillamine, 1-hydroxyethane-1,1-diphosphoric acid, dimercpatopropanol, and salicyclic acid.
33. The method of Example 25, wherein forming the first transition metal sol comprises:
   providing a primary alcohol;
   providing an acid, and
   mixing the first transition metal alkoxide with the primary alcohol and the acid.
34. The method of Example 25, wherein forming the sol mixture further comprises:
   providing a buffer agent;
   providing a surfactant; and
   mixing the buffer agent and surfactant with the first transition metal alkoxide, the second transition metal alkoxide, and the metalloid alkoxide.
35. The method of Example 25, wherein forming the sol mixture further comprises:
   providing a dye or pigment; and
   mixing the dye or pigment with the first transition metal alkoxide, the second transition metal alkoxide, and the metalloid alkoxide.
36. The method of Example 25, wherein the method further comprises:
   heating the sol mixture, wherein the sol mixture comprises one or more sols and wherein heating the sol mixture causes the one or more sols to undergo a polycondensation reaction.
37. A coated article, comprising:
   a metal substrate; and
   a ceramic coating adhered to a surface of the metal substrate, wherein the ceramic coating comprises a ceramic material that comprises:
      a first transition metal;
      a second transition metal different from the first transition metal; and
      a metalloid; and
      an elastomer layer formed over the ceramic coating.
38. The coated article of Example 37, wherein the surface of the metal substrate comprises hydroxyl or carboxyl groups and wherein the ceramic material further comprises:
   a functional group, wherein the functional group is bonded to the hydroxyl or carboxyl groups.
39. The coated article of Example 37, wherein the ceramic material further comprises:
   a functional group, wherein the functional group is bonded to the elastomer layer.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or whether these features, elements and/or states are included or are to be performed in any particular embodiment.

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various embodiments described above can be combined to provide further embodiments. The various features and processes described above may be implemented independently of one another, or may be combined in various ways. All possible combinations and subcombinations of features of this disclosure are intended to fall within the scope of this disclosure.

1. A method of forming a coated article, the method comprising:
providing a metal substrate;
preparing a sol mixture for forming a ceramic coating, wherein preparing the sol mixture comprises:
preparing a first transition metal sol that includes a first transition metal;
preparing a second transition metal sol that includes a second transition metal that is different from the first transition metal;
preparing a metalloid sol that includes a metalloid; and
mixing the first transition metal sol, the second transition metal sol, and the metalloid sol together;
depositing the sol mixture onto a surface of the metal substrate; and
heating the metal substrate and the sol mixture to form the ceramic coating.

2. The method of claim 1, wherein preparing the first transition metal sol comprises:
providing a transition metal sol precursor compound comprising the first transition metal;
providing a solvent; and
mixing the transition metal sol precursor compound into the solvent.

3. (canceled)

4. (canceled)

5. (canceled)

6. The method of claim 2, wherein the transition metal sol precursor compound comprises a transition metal alkoxide having at least two alkoxide ligands bonded to the first transition metal.

7. (canceled)

8. (canceled)

9. The method of claim 1, wherein each of the first transition metal and the second transition metal is selected from the group consisting of copper (Cu), cobalt (Co), manganese (Mn), zinc (Zn), titanium (Ti), zirconium (Zr), tantalum (Ta), hafnium (Hf) and vanadium (V).

10. (canceled)

11. (canceled)

12. The method of claim 1, wherein preparing the metalloid sol comprises:
providing a metalloid sol precursor compound comprising the metalloid;
providing a solvent; and
mixing the metalloid sol precursor compound into the solvent.

13. (canceled)

14. The method of claim 12, wherein the metalloid is selected from the group consisting of silicon (Si), boron (B), germanium (Ge), and antimony (Sb).

15. (canceled)

16. The method of claim 1, wherein preparing the sol mixture further comprises:
preparing a functionalized metalloid sol; and
mixing the functionalized metalloid sol with the first transition metal sol, the second transition metal sol, and the metalloid sol.

17. The method of claim 16, wherein preparing the functionalized metalloid sol comprises:
providing a functionalized metalloid sol precursor compound comprising a metalloid atom, one or more alkoxide ligands, and a functional group ligand;
providing a solvent; and
mixing the functionalized metalloid sol precursor compound and the solvent.

18. The method of claim 17, wherein the functionalized metalloid sol precursor compound comprises a silane.

19. (canceled)

20. The method of claim 17, wherein the functional group ligand comprises an epoxy functional group, an isocyanate functional group, or an amine functional group.

21. The method of claim 1, wherein the metal substrate comprises a steel.

22. (canceled)

23. (canceled)

24. (canceled)

25. A method of coating a metal substrate, the method comprising:
forming a sol mixture, wherein forming the sol mixture comprises:
forming a first transition metal sol from a first transition metal alkoxide;
forming a second transition metal sol from a second transition metal alkoxide that is different from the first transition metal alkoxide;
forming a metalloid sol from a metalloid alkoxide; and
mixing the first transition metal sol, the second transition metal sol, and the metalloid sol together; and
depositing the sol mixture onto the metal substrate.

26. The method of claim 25, further comprising:
after depositing the sol mixture onto the metal substrate, heating the coating and the metal substrate.

27. The method of claim 25, wherein the first transition metal alkoxide comprises a first transition metal and wherein the second transition metal alkoxide comprises a second transition metal that is different from the first transition metal.

28. (canceled)

29. (canceled)

30. The method of claim 25, wherein forming the sol mixture further comprises:
forming a functionalized metalloid sol from a functionalized metalloid alkoxide; and
mixing the functionalized metalloid sol with the first transition metal sol, the second transition metal sol, and the metalloid sol.

31. The method of claim 30, wherein forming the sol mixture further comprises:
providing a chelating agent; and
mixing the chelating agent with first transition metal sol, the second transition metal sol, the metalloid sol, and the functionalized metalloid sol.

32. (canceled)

33. The method of claim 25, wherein forming the first transition metal sol comprises:
providing a primary alcohol;
providing an acid; and
mixing the first transition metal alkoxide with the primary alcohol and the acid.

34. The method of claim 25, wherein forming the sol mixture further comprises:
providing a buffer agent;
providing a surfactant; and
mixing the buffer agent and surfactant with the first transition metal alkoxide, the second transition metal alkoxide, and the metalloid alkoxide.

35. The method of claim 25, wherein forming the sol mixture further comprises:
providing a dye or pigment; and
mixing the dye or pigment with the first transition metal alkoxide, the second transition metal alkoxide, and the metalloid alkoxide.

36. The method of claim 25, wherein the method further comprises:
heating the sol mixture, wherein the sol mixture comprises one or more sols and wherein heating the sol mixture causes the one or more sols to undergo a polycondensation reaction.

37. A coated article, comprising:
a metal substrate; and
a ceramic coating adhered to a surface of the metal substrate, wherein the ceramic coating comprises a ceramic material that comprises:
a first transition metal;
a second transition metal different from the first transition metal; and
a metalloid; and
an elastomer layer formed over the ceramic coating.

38. The coated article of claim 37, wherein the surface of the metal substrate comprises hydroxyl or carboxyl groups and wherein the ceramic material further comprises:
a functional group, wherein the functional group is bonded to the hydroxyl or carboxyl groups.

39. The coated article of claim 37, wherein the ceramic material further comprises:
a functional group, wherein the functional group is bonded to the elastomer layer.
